(19) United States
(12) Patent Application Publication
(10) Pub. No.: US 2026/0189348 A1
(43) Pub. Date: Jul. 2, 2026

(54) BEAM TRACKING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/408,310

(22) Filed: Dec. 3, 2025

Related U.S. Application Data
(60) Provisional application No. 63/740,195, filed on Dec. 30, 2024.
(60) Provisional application No. 63/740,208, filed on Dec. 30, 2024.

(51) Int. Cl. H04L 5/00

(52) U.S. Cl. CPC H04L 5/0091; H04L 5/0051

(57) ABSTRACT

Methods and apparatuses for beam tracking. A method performed by a user equipment (UE) includes receiving information related to acquisition of channel direction, receiving an indication of a first transmission configuration indication (TCI) state and a second TCI state, and identifying a first reference signal (RS) and a second RS associated with the first and second TCI states, respectively. The method further includes determining, based on the information, a first metric and a second metric associated with the first and second RSs, respectively, determining a third metric based on the information that is a function of the first and second metrics, and transmitting the third metric.

### CROSS-REFERENCE TO RELATED AND CLAIM OF PRIORITY

The present application claims priority under 35 U.S.C. § 119(e) to U.S. Provisional Patent Application No. 63/740,195 filed on Dec. 30, 2024; and U.S. Provisional Patent Application No. 63/740,208 filed on Dec. 30, 2024, each of which are hereby incorporated by reference in their entirety.

### TECHNICAL FIELD

The present disclosure relates generally to wireless communication systems and, more specifically, the present disclosure relates to beam tracking methods and apparatuses.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam tracking.

In one embodiment, a user equipment (UE) is provided. The UE includes a transceiver configured to receive information related to acquisition of channel direction and receive an indication of a first transmission configuration indication (TCI) state and a second TCI state. The UE further includes a processor operably coupled with the transceiver. The processor is configured to identify a first reference signal (RS) and a second RS associated with the first and second TCI states, respectively, determine, based on the information, a first metric and a second metric associated with the first and second RSs, respectively, and determine a third metric based on the information, wherein the third metric is a function of the first and second metrics. The transceiver is further configured to transmit the third metric.

In another embodiment, a base station is provided. The base station includes a processor and a transceiver operably coupled with the processor. The transceiver is configured to transmit information related to acquisition of channel direction, transmit an indication of a first TCI state and a second TCI state, and receive a third metric that is a function of first and second metrics. A first RS and a second RS are associated with the first and second TCI states, respectively. The first metric and the second metric are associated with the first and second RSs, respectively.

In yet another embodiment, a method performed by a UE is provided. The method includes receiving information related to acquisition of channel direction, receiving an indication of a first TCI state and a second TCI state, and identifying a first RS and a second RS associated with the first and second TCI states, respectively. The method further includes determining, based on the information, a first metric and a second metric associated with the first and second RSs, respectively, determining a third metric based on the information that is a function of the first and second metrics, and transmitting the third metric.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of a two-dimensional antenna array structure according to embodiments of the present disclosure;

FIG. 8 illustrates another example of a two-dimensional antenna array structure according to embodiments of the present disclosure;

FIG. 9 illustrates an example of using a TCI state to indicate a pair of RSs for beam tracking according to embodiments of the present disclosure;

FIG. 10 illustrates an example of indicating a pair of RSs for beam tracking according to embodiments of the present disclosure;

FIG. 11 illustrates an example of using a lookup table to characterize the association/mapping relation between RSs/RS resources for beam tracking according to embodiments of the present disclosure;

FIG. 12 illustrates an example of indicating a pair of TCI states for beam tracking according to embodiments of the present disclosure;

FIG. 13 illustrates an example of using a TCI state to indicate a group of three RSs for beam tracking according to embodiments of the present disclosure;

FIG. 14 illustrates an example of indicating a group of three RSs for beam tracking according to embodiments of the present disclosure;

FIG. 15 illustrates an example of indicating a group of three TCI states for beam tracking according to embodiments of the present disclosure;

FIG. 16 illustrates an example CSI/beam report according to embodiments of the present disclosure;

FIG. 17 illustrates another example CSI/beam report according to embodiments of the present disclosure; and

FIG. 18 illustrates an example method performed by a UE in a wireless communication system according to embodiments of the present disclosure.

### DETAILED DESCRIPTION

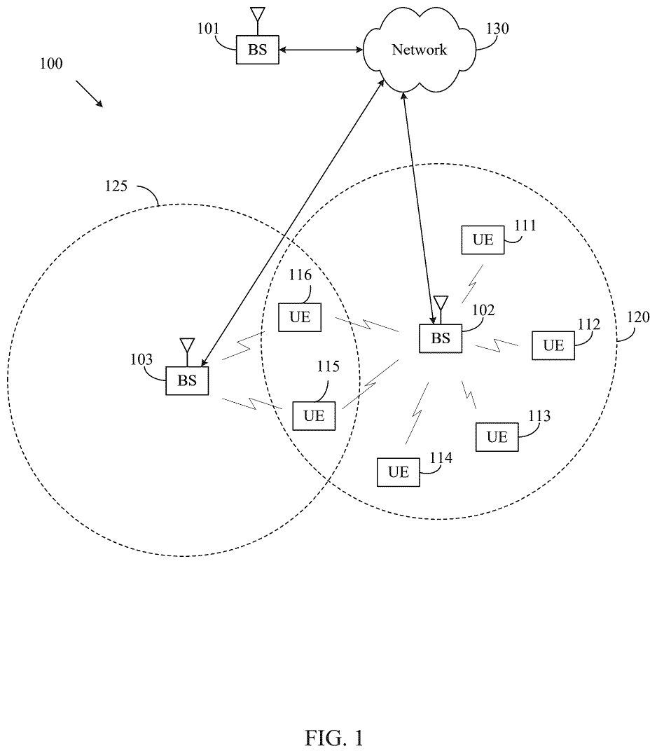

FIGS. 1-18, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1] 3GPP TS 38.211 v16.1.0, “NR; Physical channels and modulation;” [REF 2] 3GPP TS 38.212 v16.1.0, “NR; Multiplexing and Channel coding;” [REF 3] 3GPP TS 38.213 v16.1.0, “NR; Physical Layer Procedures for Control;” [REF 4] 3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing beam tracking. In certain embodiments, one or more of the BSs 101-103 include circuitry, programing, or a combination thereof to support beam tracking.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

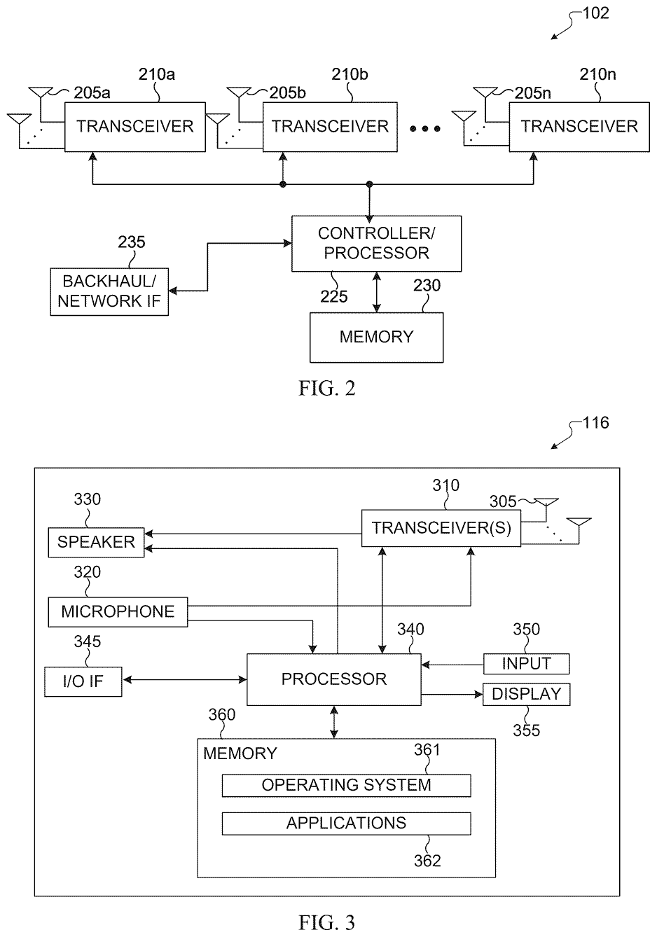

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting beam tracking. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize beam tracking as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

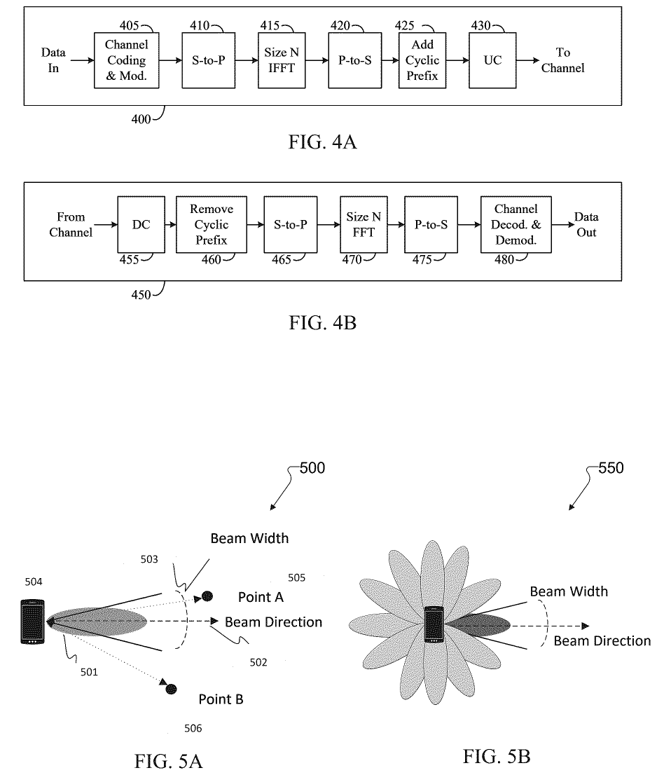

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support beam tracking as described in embodiments of the present disclosure. In some embodiments, the receive path 450 is configured to support beam tracking as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where Nis the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

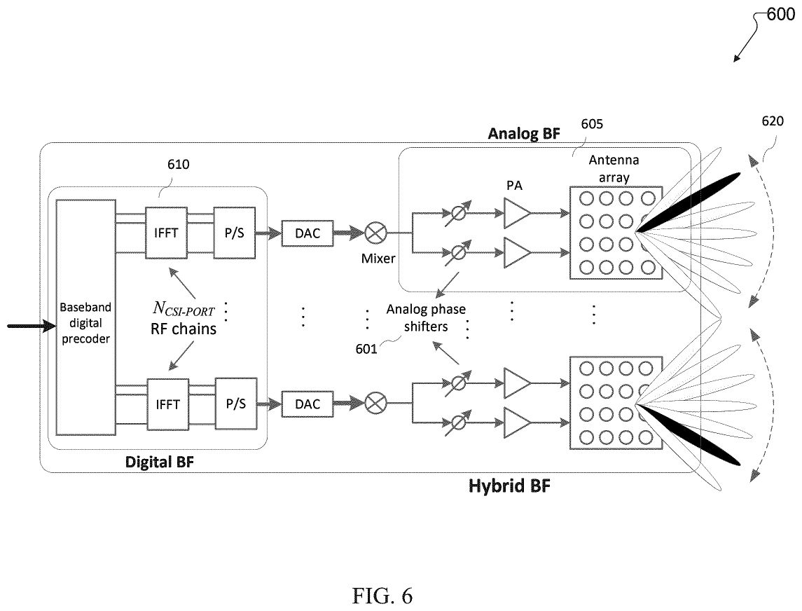

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In this Disclosure, a Beam is Determined by Either of:
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure recognize that at mmWave frequencies, or FR2 in the 3GPP NR, one or more analog TX-RX beam pair links (BPLs) are established between the gNB and the UE to transmit/receive the data/control information. To ensure sufficient BPL quality, an exhaustive search of all combinations of TX-RX beams could be performed (also referred to as one-stage beam acquisition design), from which the best TX-RX beam pair(s) could be determined. A large amount of TX-RX beam sweeping/scanning is required though, which could be a source of overhead. Especially with large number of TCI states and/or when the UE is moving at high speed, frequent and exhaustive TX-RX beam pairs search would introduce significantly large signaling overhead and access latency, which is undesired for various deployment scenarios and system settings in the 5G NR and future-generation (e.g., 6G) wireless communications systems. Hence, there is a need of efficient yet effective beam tracking method(s) to reduce the beam acquisition latency and overhead.

Accordingly, embodiments of the present disclosure provide sum/difference beams based beam tracking designs, which can reduce beam acquisition overhead hence reducing beam switching latency. This disclosure also specifies various signaling alternatives and the corresponding UE's operations to support or enable the proposed beam tracking methods.

In one embodiment, a UE could be configured or provided or indicated by the network, a pair of a first RS or RS resource and a second RS or RS resource, to perform e.g. L1 measurement(s). In one example, the first and second RS or RS resources—e.g., in terms/form their RS/resource IDs/indexes—could be provided or configured in a same higher layer parameter denoted by resourcePair. In another example, the first and second RS or RS resources could be respectively associated with a first and a second TCI states configured, activated or indicated to the UE according to or following those specified herein in the present disclosure.

Method-1: the first RS or RS resource could be referred to as a sum beam having a beam pattern/structure of

$${\frac{1}{\sqrt{{N}_{t}}} [ 1 , … , {e}^{- j ( \frac{{N}_{t}}{2} - 1 ) μ} , {e}^{- j ( \frac{{N}_{t}}{2} ) μ} , … , {e}^{- j ( {N}_{t} - 1 ) μ} ]}^{T} ,$$

and the second RS or RS resource could be referred to as a difference beam having a beam pattern/structure of

$${\frac{1}{\sqrt{{N}_{t}}} [ 1 , … , {e}^{- j ( \frac{{N}_{t}}{2} 1 )} μ , - {e}^{- j ( \frac{{N}_{t}}{2} ) μ} , … , - {e}^{- j ( {N}_{t} - 1 ) μ} ]}^{T} ,$$

where Nₜ represents the total number of (transmit) antenna elements, and u is the steering direction. Furthermore, denote the received signals or signal samples for the sum and difference beams as rx_sig_s and rx_sig_d. The UE could then determine, identify or formulate a first sum-difference function as

$$f ( θ ) = \{ rx\_sig \_s / rx\_sig \_d \} ,$$

where θ is the actual channel angular direction, and [symbol] {x} extracts the imaginary part of the input x. The corresponding first sum-difference function can be further expressed as

$$f ( θ ) = \frac{sin ( \frac{{N}_{t}}{2} ( θ - μ ) )}{1 - cos ( \frac{{N}_{t}}{2} ( θ - μ ) )} = cot ( \frac{{N}_{t}}{4} ( θ - μ ) ) .$$

The UE could then invert the first sum-difference function ƒ(·) and obtain the corresponding channel angle estimation result as

$$\hat{θ} = {f}^{- 1} ( θ ) = μ + \frac{4}{{N}_{t}} {cos}^{- 1} ( \frac{{N}_{t}}{4} ( θ - μ ) ) .$$

Method-1A: for a given elevation angel or angular direction denoted by v, an azimuth sum beam could have a beam pattern/structure as

$${s}_{v} ( μ ) = {\frac{1}{\sqrt{{N}_{t}}} [ 1 , … , {e}^{- j ( \frac{{N}_{t}}{2} - 1 ) μ} , {e}^{- j ( \frac{{N}_{t}}{2} ) μ} , … , {e}^{- j ( {N}_{t} - 1 ) μ} ]}^{T} ,$$

and an azimuth difference beam could have a beam pattern/structure as

$${d}_{v} ( μ ) = {\frac{1}{\sqrt{{N}_{t}}} [ 1 , … , {e}^{- j ( \frac{{N}_{t}}{2} - 1 ) μ} , - {e}^{- j ( \frac{{N}_{t}}{2} ) μ} , … , - {e}^{- j ( {N}_{t} - 1 ) μ} ]}^{T} ,$$

where Nₜ represents the total number of (transmit) antenna elements in the azimuth domain, and u is the azimuth steering direction. Furthermore, denote the received signals or signal samples for the azimuth sum and difference beams as az_rx_sig_s and az_rx_sig_d. The UE could then determine, identify or formulate a first azimuth sum-difference function as

$$f ( θ ) = ℶ \{ az\_rx \_sig \_s / az\_rx \_sig \_d \} ,$$

where θ is the actual channel azimuth angular direction, and [symbol] {x} extracts the imaginary part of the input x. The corresponding first azimuth sum-difference function can be further expressed as

$$f ( θ ) = \frac{sin ( \frac{{N}_{t}}{2} ( θ - μ ) )}{1 - cos ( \frac{{N}_{t}}{2} ( θ - μ ) )} = cot ( \frac{{N}_{t}}{4} ( θ - μ ) ) .$$

The UE could then invert the first azimuth sum-difference function ƒ(·) and obtain the corresponding channel azimuth angle estimation result as

$$\hat{θ} = {f}^{- 1} ( θ ) = μ + \frac{4}{{N}_{t}} {cos}^{- 1} ( \frac{{N}_{t}}{4} ( θ - μ ) ) .$$

Furthermore, for a given azimuth angel or angular direction denoted by u, an elevation sum beam could have a beam pattern/structure as

$${s}_{v} ( v ) = {\frac{1}{\sqrt{{M}_{t}}} [ 1 , … , {e}^{- j ( \frac{{M}_{t}}{2} - 1 ) v} , {e}^{- j ( \frac{{M}_{t}}{2} ) v} , … , {e}^{- j ( {M}_{t} - 1 ) v} ]}^{T} ,$$

and an elevation difference beam could have a beam as

$${d}_{μ} ( v ) = {\frac{1}{\sqrt{{M}_{t}}} [ 1 , … , {e}^{- j ( \frac{{M}_{t}}{2} - 1 ) v} , - {e}^{- j ( \frac{{M}_{t}}{2} ) v} , … , - {e}^{- j ( {M}_{t} - 1 ) v} ]}^{T} ,$$

where Mₜ represents the total number of (transmit) antenna elements in the elevation domain, and v is the elevation steering direction. Furthermore, denote the received signals or signal samples for the elevation sum and difference beams as el_rx_sig_s and el_rx_sig_d. The UE could then determine, identify or formulate a first elevation sum-difference function as

$$f ( θ ) = \{ el\_rx \_sig \_s / el\_rx \_sig \_d \} ,$$

where ϑ is the actual channel elevation angular direction, and [symbol] {x} extracts the imaginary part of the input x. The corresponding first elevation sum-difference function can be further expressed as

$$f ( ϑ ) = \frac{sin ( \frac{{M}_{t}}{2} ( ϑ - v ) )}{1 - cos ( \frac{{M}_{t}}{2} ( ϑ - v ) )} = cot ( \frac{{M}_{t}}{4} ( ϑ - v ) ) .$$

The UE could then invert the first elevation sum-difference function ƒ(·) and obtain the corresponding channel elevation angle estimation result as

$$\hat{ϑ} = {f}^{- 1} ( ϑ ) = v + \frac{4}{{M}_{t}} {cos}^{- 1} ( \frac{{M}_{t}}{4} ( ϑ - v ) ) .$$

According to those specified herein in the present disclosure, an overall sum beam for a two-dimensional (2D) antenna array that has u as the azimuth steering direction and v as the elevation steering direction could correspond to:

$$s = {s}_{v} ( μ ) ⊗ {s}_{μ} ( v )$$

and an overall difference beam for the 2D antenna array corresponding to the overall sum beam s could correspond to:

$$d = {d}_{v} ( μ ) ⊗ {d}_{μ} ( v )$$

where ⊗ represents kronecker product.

Method-2: the first RS or RS resource could be referred to as a sum beam having a beam pattern/structure of

$${\frac{1}{\sqrt{{N}_{t}}} [ 1 , {e}^{- {j μ}_{a}} , … , {e}^{- j ( \frac{{N}_{t}}{2} - 1 ) {μ}_{a}} , {e}^{- j ( \frac{{N}_{t}}{2} ) {μ}_{a}} , … , {e}^{- j ( {N}_{t} - 1 ) {μ}_{a}} ]}^{T} ,$$

and the second RS or RS resource could be referred to as a difference beam having a beam pattern/structure of

$${\frac{1}{\sqrt{{N}_{t}}} [ 1 , {e}^{- {j μ}_{b}} , … , {e}^{- j ( \frac{{N}_{t}}{2} - 1 ) {μ}_{b}} , {e}^{- j ( \frac{{N}_{t}}{2} ) {μ}_{b}} , … , {e}^{- j ( {N}_{t} - 1 ) {μ}_{b}} ]}^{T} ,$$

where μ_{α} and μ_{b} are the steering directions of the sum and difference beams respectively. Furthermore, denote the received signal qualities such as L1 measurements including L1-RSRPs for the sum and difference beams as rx_pw_s and rx_pw_d. The UE could then determine, identify or formulate a second sum-difference function as

$$\\ f ( θ ) = ( rx\_pw \_s - rx\_pw \_d ) / ( rx\_pw \_s + rx\_pw \_d ) ,$$

where θ is the actual channel angular direction. If μ_{α}=μ−δ and μ_{b}=μ+δ, the second sum-difference function can be rewritten as

$$\\ f ( θ ) = - \frac{sin ( θ - μ ) sin ( δ )}{1 - cos ( θ - μ ) cos ( δ )} .$$

The UE can then invert the second sum-difference function ƒ(·) and obtain the corresponding channel angle estimation result as

$$\\ \hat{θ} = {f}^{- 1} ( θ ) = μ - {sin}^{- 1} ( \frac{f ( θ ) sin ( δ ) - f ( θ ) \sqrt{1 - {f}^{2} ( θ )} sin ( δ ) cos ( δ )}{{sin}^{2} ( δ ) + {f}^{2} ( θ ) {cos}^{2} ( δ )} ) .$$

Method-2A: for a given elevation angle or angular direction denoted by v, an azimuth sum beam could have a beam pattern/structure as

$$\\ {s}_{v} ( {μ}_{a} ) = {\frac{1}{\sqrt{{N}_{t}}} [ 1 , {e}^{- j {μ}_{a}} , … , {e}^{- j ( \frac{{N}_{t}}{2} - 1 ) {μ}_{a}} , {e}^{- j ( \frac{{N}_{t}}{2} ) {μ}_{a}} , … , {e}^{- j ( {N}_{t} - 1 ) {μ}_{a}} ]}^{T} ,$$

and an azimuth difference beam could have a beam pattern/structure as

$$\\ {d}_{v} ( {μ}_{b} ) = {\frac{1}{\sqrt{{N}_{t}}} [ 1 , {e}^{- j {μ}_{b}} , … , {e}^{- j ( \frac{{N}_{t}}{2} - 1 ) {μ}_{b}} , {e}^{- j ( \frac{{N}_{t}}{2} ) {μ}_{b}} , … , {e}^{- j ( {N}_{t} - 1 ) {μ}_{b}} ]}^{T} ,$$

where μ_{α} and μ_{b} are the azimuth steering directions of the azimuth sum and difference beams respectively. Furthermore, denote the received signal qualities such as L1 measurements including L1-RSRPs for the azimuth sum and difference beams as az_rx_pw_s and az_rx_pw_d. The UE could then determine, identify or formulate a second azimuth sum-difference function as

$$\\ f ( θ ) = ( az\_rx \_pw \_s - az\_rx \_pw \_d ) / ( az\_rx \_pw \_s + az\_rx \_pw \_d ) ,$$

where θ is the actual channel azimuth angular direction. If μ_{α}=μ−δ and μ_{b}=μ+δ, the second azimuth sum-difference function can be rewritten as

$$\\ f ( θ ) = - \frac{sin ( θ - μ ) sin ( δ )}{1 - cos ( θ - μ ) cos ( δ )} .$$

The UE can then invert the second azimuth sum-difference function ƒ(·) and obtain the corresponding channel azimuth angle estimation result as

$$\\ \hat{θ} = {f}^{- 1} ( θ ) = μ - {sin}^{- 1} ( \frac{f ( θ ) sin ( δ ) - f ( θ ) \sqrt{1 - {f}^{2} ( θ )} sin ( δ ) cos ( δ )}{{sin}^{2} ( δ ) + {f}^{2} ( θ ) {cos}^{2} ( δ )} ) .$$

Furthermore, for a given azimuth angle or angular direction denoted by μ, an elevation sum beam could have a beam pattern/structure as

$$\\ {s}_{μ} ( {v}_{a} ) = {\frac{1}{\sqrt{{M}_{t}}} [ 1 , {e}^{- {jv}_{a}} , … , {e}^{- j ( \frac{{M}_{t}}{2} - 1 ) {v}_{a}} , {e}^{- j ( \frac{{M}_{t}}{2} ) {v}_{a}} , … , {e}^{- j ( {M}_{t} - 1 ) {v}_{a}} ]}^{T} ,$$

and an elevation difference beam could have a beam pattern/structure as

$$\\ {d}_{μ} ( {v}_{b} ) = {\frac{1}{\sqrt{{M}_{t}}} [ 1 , {e}^{- {jv}_{b}} , … , {e}^{- j ( \frac{{M}_{t}}{2} - 1 ) {v}_{b}} , {e}^{- j ( \frac{{M}_{t}}{2} ) {v}_{b}} , … , {e}^{- j ( {M}_{t} - 1 ) {v}_{b}} ]}^{T} ,$$

where v_{α} and v_{b} are the elevation steering directions of the elevation sum and difference beams respectively. Furthermore, denote the received signal qualities such as L1 measurements including L1-RSRPs for the elevation sum and difference beams as el_rx_pw_s and el_rx_pw_d. The UE could then determine, identify or formulate a second elevation sum-difference function as

$$\\ f ( ϑ ) = ( el\_rx \_pw \_s - el\_rx \_pw \_d ) / ( el\_rx \_pw \_s + el\_rx \_pw \_d ) ,$$

where ⊗ is the actual channel elevation angular direction. If v_{α}=v−δ and μ_{b}=v+δ, the second elevation sum-difference function can be rewritten as

$$\\ f ( ϑ ) = - \frac{sin ( ϑ - v ) sin ( δ )}{1 - cos ( ϑ - v ) cos ( δ )} .$$

The UE can then invert the second elevation sum-difference function ƒ(·) and obtain the corresponding channel elevation angle estimation result as

$$\\ \hat{ϑ} = {f}^{- 1} ( ϑ ) = v - {sin}^{- 1} ( \frac{f ( ϑ ) sin ( δ ) - f ( ϑ ) \sqrt{1 - {f}^{2} ( ϑ )} sin ( δ ) cos ( δ )}{{sin}^{2} ( δ ) + {f}^{2} ( ϑ ) {cos}^{2} ( δ )} ) .$$

According to those specified herein in the present disclosure, an overall sum beam for a two-dimensional (2D) antenna array that has u as the azimuth steering direction and v as the elevation steering direction could correspond to:

$$\\ s = {s}_{v} ( μ ) ⊗ {s}_{μ} ( v )$$

and an overall difference beam for the 2D antenna array corresponding to the overall sum beam s could correspond to:

$$\\ d = {d}_{v} ( μ ) ⊗ {d}_{μ} ( v )$$

where ϑ represents kronecker product.

For Method-1 and/or Method-1A and/or Method-2 and/or Method-2A as specified/defined herein in the present disclosure,
In one example (example-A), the UE could be configured or provided by the network, e.g., via/in/by higher layer RRC signaling(s)/parameter(s) CSI-ReportConfig and/or CSI-ResourceConfig, a first RS or RS resource set provided by csi-RS-ResourceSet-SumBeam comprising one or more RSs or RS resources (e.g., in terms/form of their corresponding RS/resource IDs/indexes), and a second RS or RS resource set provided by csi-RS-ResourceSet-DiffBeam comprising one or more RSs or RS resources (e.g., in terms/form of their corresponding RS/resource IDs/indexes). The first and second sets of RSs or RS resources could have the same number of RSs or RS resources configured or provided therein, and each RS or RS resource (e.g., in terms/form of its corresponding RS/resource ID/index) in the first set could be associated, mapped or linked to a RS or RS resource (e.g., in terms/form of its corresponding RS/resource ID/index) in the second set; in this case, the UE could determine or identify the association(s), mapping(s) and/or linkage(s) according to or based on one or more of:
   fixed rule(s) in system specification(s) and/or per RRC (re-)configuration: for instance, the k-th entry (hence the corresponding RS/RS resource or RS/RS resource ID/index) of/in the first set could be associated, mapped or linked to the k-th entry (hence the corresponding RS/RS resource or RS/RS resource ID/index) of/in the second set, wherein k=1, . . . , K, and K represents the total number of RS(s) or RS resource(s)—e.g., in terms/form the corresponding RS/resource ID(s)/index(es)—configured/provided in the first (or second) set. Alternatively, the RS/RS resource with the k-th lowest (or highest) RS/resource ID/index-among all the K≥1 RS(s)/RS resource(s) in the first set wherein k=1, . . . , K—configured/provided in the first set could be associated, mapped or linked to the RS/RS resource with the k-th lowest (or highest) RS/resource ID/index-among all the K≥1 RS(s)/RS resource(s) in the second set wherein k=1, . . . , K—configured/provided in the second set.
   network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the RS or RS resource in the first set associated/configured with the given RS/RS resource ID/index could be associated, mapped or linked to the RS or RS resource in the second set associated/configured with the (same) given RS/RS resource ID/index.
   UE's autonomous determination or selection, which could be further sent or transmitted to the network via various UL channels/signals such as CSI/beam report and/or UE's capability signaling(s)

For this design example, a RS or RS resource (in terms/form of its corresponding or respective RS/resource ID or index)-denoted by a first RS or RS resource—in the first set and its associated, mapped or linked RS or RS resource (in terms/form of its corresponding or respective RS/resource ID or index)-denoted by a second RS or RS resource—in the second set could respectively correspond to a sum beam (or a sum beam RS or RS resource) and a difference beam (or a difference beam RS or RS resource) according to or following those specified/defined herein in the present disclosure, or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned first set, the UE could then determine or identify that the determined or identified RS(s) or RS resource(s) could correspond to a sum (or difference) beam RS(s) or RS resource(s) as specified/defined herein in the present disclosure:
furthermore, the UE could identify or determine, based on the association(s), mapping(s) or linkage(s) defined/specified herein in the present disclosure, a difference (or sum) beam RS(s) or RS resource(s) from the second set associated, mapped or linked to the sum (or difference) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure,
and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned second set, the UE could then determine or identify that the determined or identified RS(s) or RS resource(s) could correspond to a difference (or sum) beam RS(s) or RS resource(s) as specified/defined herein in the present disclosure:
furthermore, the UE could identify or determine, based on the association(s), mapping(s) or linkage(s) defined/specified herein in the present disclosure, a sum (or difference) beam RS(s) or RS resource(s) from the first set associated, mapped or linked to the difference (or sum) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure.
In another example (example-B), the UE could be configured or provided by the network, e.g., via/in/by higher layer RRC signaling(s)/parameter(s) CSI-ReportConfig and/or CSI-ResourceConfig, a RS or RS resource set provided by csi-RS-ResourceSet-SumDiffBeam comprising one or more RSs or RS resources (e.g., in terms/form of their corresponding RS/resource IDs/indexes). For this design example, the UE could determine or identify sum and/or difference beam RS(s) or RS resource(s)—e.g., in terms/form of the corresponding RS/resource ID(s)/index(es)—from/in the RS or RS resource set according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS(s) or RS resource(s) in the set could correspond to sum beam RS(s) or RS resource(s), and the rest of the RS(s) or RS resource(s) in the set could correspond to difference beam RS(s) or RS resource(s), or vice versa.
   For another example, the RS(s) or RS resource(s) with odd (or even) resource ID(s)/index(es) in the set could correspond to sum beam RS(s) or RS resource(s), and the RS(s) or RS resource(s) with even (or odd) resource ID(s)/index(es) in the set could correspond to difference beam RS(s) or RS resource(s).
   For another example, the UE could be provided or configured by the network e.g. via higher layer RRC signaling(s)/parameter(s) CSI-ReportConfig and/or CSI-ResourceConfig a bitmap associated/corresponding/specific to the set with each entry/bit position of the bitmap corresponding to a RS or RS resource—e.g., in terms/form of its RS/resource ID/index—in the set. In this case, when/if an entry/bit position of/in the bitmap is set to ‘1’ (or ‘0’), the RS or RS resource corresponding to the entry/bit position could correspond to a sum beam RS or RS resource, and when/if an entry/bit position of/in the bitmap is set to ‘0’ (or ‘1’), the RS or RS resource corresponding to the entry/bit position could correspond to a difference beam RS or RS resource.
   For another example, higher layer parameter(s)/signaling(s) e.g. NZP-CSI-RS-Resource that provides or configures a RS or RS resource in the set could contain, comprise, include, configure or provide an indicator; when/if the indicator is set to ‘1’ (or ‘0’) or ‘sumBeam’, the RS or RS resource could correspond to a sum beam RS or RS resource as specified or defined herein in the present disclosure, and when/if the indicator is set to ‘0’ (or ‘1’) or ‘diffBeam’, the RS or RS resource could correspond to a difference beam RS or RS resource as specified or defined herein in the present disclosure.

The UE could determine or identify association(s), mapping(s) and/or linkage(s) between sum and difference beam RSs or RS resources according to or based on:
For example, the UE could first identify or determine a set A of RS(s) or RS resource(s)—e.g., in terms/form of the corresponding RS/resource ID(s)/index(es)—comprising the sum beam RS(s) or RS resource(s) from/in the set, and a set B of RS(s) or RS resource(s)—e.g., in terms/form of the corresponding RS/resource ID(s)/index(es)—comprising the difference beam RS(s) or RS resource(s) from/in the set. In this case, the UE could determine or identify the association(s), mapping(s) and/or linkage(s) between the sum and difference beam RSs or RS resources according to or based on those specified or described or defined in the example-A by replacing the first set in the example-A with the set A and the second set in the example-A with the set B.
For another example, for the set provided by csi-RS-ResourceSet-SumDiffBeam, when/if the n-th entry in/of the set or the RS or RS resource with the n-th lowest (or highest) RS/resource ID/index in/of the set corresponds to a sum beam RS or RS resource, and the (n−1)-th and/or (n+1)-th entry in/of the set or the RS(s) or RS resource(s) with the (n−1)-th and/or (n+1)-th lowest (or highest) RS/resource ID(s)/index(es) in/of the set corresponds to difference beam RS(s) or RS resource(s), the UE could determine or identify that the sum beam RS or RS resource here could be associated, mapped or linked to the difference beam RS(s) or RS resource(s) defined in this example, wherein n∈{1, . . . , N} and N represents the total number of RS(s) or RS resource(s) in the set.
For another example, for the set provided by csi-RS-ResourceSet-SumDiffBeam, when/if the n-th entry in/of the set or the RS or RS resource with the n-th lowest (or highest) RS/resource ID/index in/of the set corresponds to a difference beam RS or RS resource, and the (n−1)-th and/or (n+1)-th entry in/of the set or the RS(s) or RS resource(s) with the (n−1)-th and/or (n+1)-th lowest (or highest) RS/resource ID(s)/index(es) in/of the set corresponds to sum beam RS(s) or RS resource(s), the UE could determine or identify that the difference beam RS or RS resource here could be associated, mapped or linked to the sum beam RS(s) or RS resource(s) defined in this example, wherein n∈{1, . . . , N} and N represents the total number of RS(s) or RS resource(s) in the set.

For this design example, when/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) corresponds to a sum (or difference) beam RS(s) or RS resource(s) according to or following those specified/defined herein in the present disclosure:
the UE could identify or determine, based on the association(s), mapping(s) or linkage(s) defined/specified herein in the present disclosure, a difference (or sum) beam RS(s) or RS resource(s) associated, mapped or linked to the sum (or difference) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure,
   and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) corresponds to a difference (or sum) beam RS(s) or RS resource(s) as specified/defined herein in the present disclosure:
the UE could identify or determine, based on the association(s), mapping(s) or linkage(s) defined/specified herein in the present disclosure, a sum (or difference) beam RS(s) or RS resource(s) associated, mapped or linked to the difference (or sum) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure.
In another example (example-C), the UE could be configured or provided by the network, e.g., via/in/by higher layer RRC signaling(s)/parameter(s) CSI-ReportConfig and/or CSI-ResourceConfig, N (N≥1) first RS or RS resource sets each provided by csi-RS-ResourceSet-AzSumBeam and/or associated with a resource set ID provided by azSumBeam-resourceSetId and comprising one or more azimuth sum beam RSs or RS resources (e.g., in terms/form of their corresponding RS/resource IDs/indexes), and N (N≥1) second RS or RS resource sets each provided by csi-RS-ResourceSet-AzDiffBeam and/or associated with a resource set ID provided by azDiffBeam-resourceSetId and comprising one or more azimuth difference beam RSs or RS resources (e.g., in terms/form of their corresponding RS/resource IDs/indexes); in this case, the n-th (n∈{1, . . . , N}) first and second sets of RSs or RS resources could have the same number of RSs or RS resources configured or provided therein,
   for example, the UE could determine or identify bitwidth for/of an (or each) azimuth sum (or difference) beam RS or RS resource ID/index in the n-th (n∈{1, . . . , N} or n={1, . . . , N}) first (or second) set according to or based on the number (Nset≥1) of azimuth sum (or difference) beam RS(s) or RS resource(s)—e.g., in terms/form of the corresponding RS/resource ID(s)/index(es)—configured/provided in the n-th first (or second) set; in this case, the bitwidth could correspond to [log ₂ (Nset)], and the azimuth sum (or difference) beam RS or RS resource ID(s)/index(es) in a first (or second) set could be referred to as local RS/resource ID(s)/index(es).
   for another example, the UE could determine or identify bitwidth for/of an (or each) azimuth sum (or difference) beam RS or RS resource ID/index in the n-th (n∈{1, . . . , N} or n={1, . . . , N}) first (or second) set according to or based on the total number (Ntot≥1) of azimuth sum (or difference) beam RS(s) or RS resource(s)—e.g., in terms/form of the corresponding RS/resource ID(s)/index(es)—configured/provided in all the N first (or second) sets; in this case, the bitwidth could correspond to [log ₂ (Ntot)], and the azimuth sum (or difference) beam RS or RS resource ID(s)/index(es) in a first (or second) set could be referred to as global RS/resource ID(s)/index(es).

Furthermore, each azimuth sum beam RS or RS resource (e.g., in terms/form of its corresponding RS/resource ID/index) in the n-th (n∈{1, . . . , N} or n={1, . . . , N}) first set could be associated, mapped or linked to an azimuth difference beam RS or RS resource (e.g., in terms/form of its corresponding RS/resource ID/index) in the n-th (n∈{1, . . . , N} or n={1, . . . , N}) second set; in this case, the UE could determine or identify the association(s), mapping(s) and/or linkage(s) according to or based on one or more of:
fixed rule(s) in system specification(s) and/or per RRC (re-)configuration: for instance, the k-th entry (hence the corresponding RS/RS resource or RS/RS resource ID/index) of/in the n-th first set could be associated, mapped or linked to the k-th entry (hence the corresponding RS/RS resource or RS/RS resource ID/index) of/in the n-th second set, wherein k=1, . . . , Nset, and Nset represents the total number of azimuth sum (or difference) beam RS(s) or RS resource(s)—e.g., in terms/form the corresponding RS/resource ID(s)/index(es)—configured/provided in the n-th first (or second) set. Alternatively, the azimuth sum beam RS/RS resource with the k-th lowest (or highest) RS/resource ID/index-among all the Nset≥1 azimuth sum beam RS(s)/RS resource(s) in the first set wherein k=1, . . . , Nset-configured/provided in the n-th first set could be associated, mapped or linked to the azimuth difference beam RS/RS resource with the k-th lowest (or highest) RS/resource ID/index-among all the Nset≥1 azimuth difference beam RS(s)/RS resource(s) in the n-th second set wherein k=1, . . . , Nset-configured/provided in the n-th second set.
network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the azimuth sum beam RS or RS resource in the n-th first set associated/configured with the given RS/RS resource ID/index could be associated, mapped or linked to the azimuth difference beam RS or RS resource in the n-th second set associated/configured with the (same) given RS/RS resource ID/index.
UE's autonomous determination or selection, which could be further sent or transmitted to the network via various UL channels/signals such as CSI/beam report and/or UE's capability signaling(s)

According to or following those specified herein in the present disclosure, a RS or RS resource (in terms/form of its corresponding or respective RS/resource ID or index)-denoted by a first RS or RS resource—in the n-th first set and its associated, mapped or linked RS or RS resource (in terms/form of its corresponding or respective RS/resource ID or index)-denoted by a second RS or RS resource—in the n-th second set could respectively correspond to an azimuth sum beam (or an azimuth sum beam RS or RS resource) and an azimuth difference beam (or an azimuth difference beam RS or RS resource), or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the n-th first set, the UE could then determine or identify that the determined or identified RS(s) or RS resource(s) could correspond to an azimuth sum beam RS(s) or RS resource(s) as specified/defined herein in the present disclosure—when/if the azimuth sum beam RS or RS resource ID/index is a local RS/resource ID/index as specified/defined herein in the present disclosure, the UE could determine or identify the resource set ID/index (provided by azSumBeam-resourceSetId) of/for the n-th first set according to or based on: fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s); for instance, the UE could be provided or configured by/in/via higher layer RRC signaling(s)/parameter(s) e.g. CSI-ReportConfig, CSI-ResourceConfig and/or TCI-State that provides or configures the TCI state the resource set ID/index of/for the n-th first set:
furthermore, the UE could identify or determine, based on the association(s), mapping(s) or linkage(s) defined/specified herein in the present disclosure, an azimuth difference beam RS(s) or RS resource(s) from the n-th second set associated, mapped or linked to the azimuth sum beam RS(s) or RS resource(s);
in addition, the UE could then derive, determine or identify, based on the identified or determined azimuth sum and difference beam RSs or RS resources, a/th corresponding azimuth sum-difference function ƒ(·), and obtain the corresponding channel azimuth angle estimation result according to or following those specified herein in the present disclosure,
and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the n-th second set, the UE could then determine or identify that the determined or identified RS(s) or RS resource(s) could correspond to an azimuth difference beam RS(s) or RS resource(s) as specified/defined herein in the present disclosure—when/if the azimuth difference beam RS or RS resource ID/index is a local RS/resource ID/index as specified/defined herein in the present disclosure, the UE could determine or identify the resource set ID/index (provided by azDiffBeam-resourceSetId) of/for the n-th second set according to or based on: fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s); for instance, the UE could be provided or configured by/in/via higher layer RRC signaling(s)/parameter(s) e.g. CSI-ReportConfig, CSI-ResourceConfig and/or TCI-State that provides or configures the TCI state the resource set ID/index of/for the n-th second set:
furthermore, the UE could identify or determine, based on the association(s), mapping(s) or linkage(s) defined/specified herein in the present disclosure, an azimuth sum beam RS(s) or RS resource(s) from the n-th first set associated, mapped or linked to the azimuth difference beam RS(s) or RS resource(s);
in addition, the UE could then derive, determine or identify, based on the identified or determined azimuth sum and difference beam RSs or RS resources, a/th corresponding azimuth sum-difference function ƒ(·), and obtain the corresponding channel azimuth angle estimation result according to or following those specified herein in the present disclosure.
In another example (example-D), the UE could be configured or provided by the network, e.g., via/in/by higher layer RRC signaling(s)/parameter(s) CSI-ReportConfig and/or CSI-ResourceConfig, M (M≥1) third RS or RS resource sets each provided by csi-RS-ResourceSet-ElSumBeam and/or associated with a resource set ID provided by elSumBeam-resourceSetId and comprising one or more elevation sum beam RSs or RS resources (e.g., in terms/form of their corresponding RS/resource IDs/indexes), and M (M≥1) fourth RS or RS resource sets each provided by csi-RS-ResourceSet-ElDiffBeam and/or associated with a resource set ID provided by elDiffBeam-resourceSetId and comprising one or more elevation difference beam RSs or RS resources (e.g., in terms/form of their corresponding RS/resource IDs/indexes); in this case, the m-th (m∈{1, . . . , M}) third and fourth sets of RSs or RS resources could have the same number of RSs or RS resources configured or provided therein,
for example, the UE could determine or identify bitwidth for/of an (or each) elevation sum (or difference) beam RS or RS resource ID/index in the m-th (m∈{1, . . . , M} or m={1, . . . , M}) third (or fourth) set according to or based on the number (Mset≥1) of elevation sum (or difference) beam RS(s) or RS resource(s)—e.g., in terms/form of the corresponding RS/resource ID(s)/index(es)—configured/provided in the m-th third (or fourth) set; in this case, the bitwidth could correspond to [log ₂ (Mset)], and the elevation sum (or difference) beam RS or RS resource ID(s)/index(es) in a third (or fourth) set could be referred to as local RS/resource ID(s)/index(es).
for another example, the UE could determine or identify bitwidth for/of an (or each) elevation sum (or difference) beam RS or RS resource ID/index in the m-th (m∈{1, . . . , M} or m={1, . . . , M}) third (or fourth) set according to or based on the total number (Mtot≥1) of elevation sum (or difference) beam RS(s) or RS resource(s)—e.g., in terms/form of the corresponding RS/resource ID(s)/index(es)—configured/provided in all the M third (or fourth) sets; in this case, the bitwidth could correspond to [log ₂ (Mtot)], and the elevation sum (or difference) beam RS or RS resource ID(s)/index(es) in a third (or fourth) set could be referred to as global RS/resource ID(s)/index(es).

Furthermore, each elevation sum beam RS or RS resource (e.g., in terms/form of its corresponding RS/resource ID/index) in the m-th (m∈{1, . . . , M} or m={1, . . . , M}) third set could be associated, mapped or linked to an elevation difference beam RS or RS resource (e.g., in terms/form of its corresponding RS/resource ID/index) in the m-th (m∈{1, . . . , M} or m={1, . . . , M}) fourth set; in this case, the UE could determine or identify the association(s), mapping(s) and/or linkage(s) according to or based on one or more of:
fixed rule(s) in system specification(s) and/or per RRC (re-)configuration: for instance, the k-th entry (hence the corresponding RS/RS resource or RS/RS resource ID/index) of/in the m-th third set could be associated, mapped or linked to the k-th entry (hence the corresponding RS/RS resource or RS/RS resource ID/index) of/in the m-th fourth set, wherein k=1, . . . , Mset, and Mset represents the total number of elevation sum (or difference) beam RS(s) or RS resource(s)—e.g., in terms/form the corresponding RS/resource ID(s)/index(es)—configured/provided in the n-th third (or fourth) set. Alternatively, the elevation sum beam RS/RS resource with the k-th lowest (or highest) RS/resource ID/index-among all the Mset≥1 elevation sum beam RS(s)/RS resource(s) in the third set wherein k=1, . . . , Mset—configured/provided in the m-th third set could be associated, mapped or linked to the elevation difference beam RS/RS resource with the k-th lowest (or highest) RS/resource ID/index-among all the Mset≥1 elevation difference beam RS(s)/RS resource(s) in the m-th fourth set wherein k=1, . . . , Mset—configured/provided in the m-th fourth set.
network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the elevation sum beam RS or RS resource in the m-th third set associated/configured with the given RS/RS resource ID/index could be associated, mapped or linked to the elevation difference beam RS or RS resource in the m-th fourth set associated/configured with the (same) given RS/RS resource ID/index.
UE's autonomous determination or selection, which could be further sent or transmitted to the network via various UL channels/signals such as CSI/beam report and/or UE's capability signaling(s)

According to or following those specified herein in the present disclosure, a RS or RS resource (in terms/form of its corresponding or respective RS/resource ID or index)-denoted by a first RS or RS resource—in the m-th third set and its associated, mapped or linked RS or RS resource (in terms/form of its corresponding or respective RS/resource ID or index)-denoted by a second RS or RS resource—in the m-th fourth set could respectively correspond to an elevation sum beam (or an elevation sum beam RS or RS resource) and an elevation difference beam (or an elevation difference beam RS or RS resource), or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the m-th third set, the UE could then determine or identify that the determined or identified RS(s) or RS resource(s) could correspond to an elevation sum beam RS(s) or RS resource(s) as specified/defined herein in the present disclosure—when/if the elevation sum beam RS or RS resource ID/index is a local RS/resource ID/index as specified/defined herein in the present disclosure, the UE could determine or identify the resource set ID/index (provided by elSumBeam-resourceSetId) of/for the m-th third set according to or based on: fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s); for instance, the UE could be provided or configured by/in/via higher layer RRC signaling(s)/parameter(s) e.g. CSI-ReportConfig, CSI-ResourceConfig and/or TCI-State that provides or configures the TCI state the resource set ID/index of/for the m-th third set:
furthermore, the UE could identify or determine, based on the association(s), mapping(s) or linkage(s) defined/specified herein in the present disclosure, an elevation difference beam RS(s) or RS resource(s) from the m-th fourth set associated, mapped or linked to the elevation sum beam RS(s) or RS resource(s);
in addition, the UE could then derive, determine or identify, based on the identified or determined elevation sum and difference beam RSs or RS resources, a/th corresponding azimuth sum-difference function ƒ(·), and obtain the corresponding channel elevation angle estimation result according to or following those specified herein in the present disclosure,
and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the m-th fourth set, the UE could then determine or identify that the determined or identified RS(s) or RS resource(s) could correspond to an elevation difference beam RS(s) or RS resource(s) as specified/defined herein in the present disclosure—when/if the elevation difference beam RS or RS resource ID/index is a local RS/resource ID/index as specified/defined herein in the present disclosure, the UE could determine or identify the resource set ID/index (provided by elDiffBeam-resourceSetId) of/for the m-th fourth set according to or based on: fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s); for instance, the UE could be provided or configured by/in/via higher layer RRC signaling(s)/parameter(s) e.g. CSI-ReportConfig, CSI-ResourceConfig and/or TCI-State that provides or configures the TCI state the resource set ID/index of/for the m-th fourth set:
furthermore, the UE could identify or determine, based on the association(s), mapping(s) or linkage(s) defined/specified herein in the present disclosure, an elevation sum beam RS(s) or RS resource(s) from the m-th third set associated, mapped or linked to the elevation difference beam RS(s) or RS resource(s);
in addition, the UE could then derive, determine or identify, based on the identified or determined azimuth sum and difference beam RSs or RS resources, a/th corresponding elevation sum-difference function ƒ(·), and obtain the corresponding channel elevation angle estimation result according to or following those specified herein in the present disclosure.
In another example (example-E), the UE could be configured or provided by the network, e.g., via/in/by higher layer RRC signaling(s)/parameter(s) CSI-ReportConfig and/or CSI-ResourceConfig, a first RS or RS resource set provided by csi-RS-ResourceSet-AzimuthBeam comprising one or more RSs or RS resources (e.g., in terms/form of their corresponding RS/resource IDs/indexes), and a second RS or RS resource set provided by csi-RS-ResourceSet-ElevationBeam comprising one or more RSs or RS resources (e.g., in terms/form of their corresponding RS/resource IDs/indexes). For this design example, the UE could determine or identify azimuth sum and/or difference beam RS(s) or RS resource(s)—e.g., in terms/form of the corresponding RS/resource ID(s)/index(es)—from/in the first RS or RS resource set, and/or elevation sum and/or difference beam RS(s) or RS resource(s)—e.g., in terms/form of the corresponding RS/resource ID(s)/index(es)—from/in the second RS or RS resource set, according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
For example, the first half of the RS(s) or RS resource(s) in the first (or second) set could correspond to azimuth (or elevation) sum beam RS(s) or RS resource(s), and the rest of the RS(s) or RS resource(s) in the first (or second) set could correspond to azimuth (or elevation) difference beam RS(s) or RS resource(s), or vice versa.
For another example, the RS(s) or RS resource(s) with odd (or even) resource ID(s)/index(es) in the first (or second) set could correspond to azimuth (or elevation) sum beam RS(s) or RS resource(s), and the RS(s) or RS resource(s) with even (or odd) resource ID(s)/index(es) in the first (or second) set could correspond to azimuth (or elevation) difference beam RS(s) or RS resource(s).
For another example, the UE could be provided or configured by the network e.g. via higher layer RRC signaling(s)/parameter(s) CSI-ReportConfig and/or CSI-ResourceConfig a bitmap associated/corresponding/specific to first (or second) set with each entry/bit position of the bitmap corresponding to a RS or RS resource—e.g., in terms/form of its RS/resource ID/index—in the first (or second) set. In this case, when/if an entry/bit position of/in the bitmap is set to ‘1’ (or ‘0’), the RS or RS resource corresponding to the entry/bit position could correspond to an azimuth (or elevation) sum beam RS or RS resource, and when/if an entry/bit position of/in the bitmap is set to ‘0’ (or ‘1’), the RS or RS resource corresponding to the entry/bit position could correspond to an azimuth (or elevation) difference beam RS or RS resource.
For another example, higher layer parameter(s)/signaling(s) e.g. NZP-CSI-RS-Resource that provides or configures a RS or RS resource in the first (or second) set could contain, comprise, include, configure or provide an indicator; when/if the indicator is set to ‘1’ (or ‘0’) or ‘sumBeam’, the RS or RS resource could correspond to an azimuth (or elevation) sum beam RS or RS resource as specified or defined herein in the present disclosure, and when/if the indicator is set to ‘0’ (or ‘1’) or ‘diffBeam’, the RS or RS resource could correspond to an azimuth (or elevation) difference beam RS or RS resource as specified or defined herein in the present disclosure.

The UE could determine or identify association(s), mapping(s) and/or linkage(s) between azimuth (or elevation) sum and difference beam RSs or RS resources according to or based on:
For example, the UE could first identify or determine a set A of RS(s) or RS resource(s)—e.g., in terms/form of the corresponding RS/resource ID(s)/index(es)—comprising the azimuth sum beam RS(s) or RS resource(s) from/in the first set and the elevation sum beam RS(s) or RS resource(s) from/in the second set, and a set B of RS(s) or RS resource(s)—e.g., in terms/form of the corresponding RS/resource ID(s)/index(es)—comprising the azimuth difference beam RS(s) or RS resource(s) from/in the first set and the elevation difference beam RS(s) or RS resource(s) from/in the second set. In this case, the UE could determine or identify the association(s), mapping(s) and/or linkage(s) between the (azimuth or elevation) sum and difference beam RSs or RS resources according to or based on those specified or described or defined in the example-A by replacing the first set in the example-A with the set A and the second set in the example-A with the set B.
For another example, the UE could first identify or determine a set A of RS(s) or RS resource(s)—e.g., in terms/form of the corresponding RS/resource ID(s)/index(es)—comprising the azimuth sum beam RS(s) or RS resource(s) from/in the first set, and a set B of RS(s) or RS resource(s)—e.g., in terms/form of the corresponding RS/resource ID(s)/index(es)—comprising the azimuth difference beam RS(s) or RS resource(s) from/in the first set. In this case, the UE could determine or identify the association(s), mapping(s) and/or linkage(s) between the azimuth sum and difference beam RSs or RS resources according to or based on those specified or described or defined in the example-B by replacing the first set in the example-B with the set A and the second set in the example-B with the set B.
For another example, the UE could first identify or determine a set A of RS(s) or RS resource(s)—e.g., in terms/form of the corresponding RS/resource ID(s)/index(es)—comprising the azimuth sum beam RS(s) or RS resource(s) from/in the first set, and a set B of RS(s) or RS resource(s)—e.g., in terms/form of the corresponding RS/resource ID(s)/index(es)—comprising the azimuth difference beam RS(s) or RS resource(s) from/in the first set. In this case, the UE could determine or identify the association(s), mapping(s) and/or linkage(s) between the azimuth sum and difference beam RSs or RS resources according to or based on those specified or described or defined in the example-B by replacing the first set in the example-B with the set A and the second set in the example-B with the set B.
For another example, the UE could first identify or determine a set A of RS(s) or RS resource(s)—e.g., in terms/form of the corresponding RS/resource ID(s)/index(es)—comprising the elevation sum beam RS(s) or RS resource(s) from/in the second set, and a set B of RS(s) or RS resource(s)—e.g., in terms/form of the corresponding RS/resource ID(s)/index(es)—comprising the elevation difference beam RS(s) or RS resource(s) from/in the second set. In this case, the UE could determine or identify the association(s), mapping(s) and/or linkage(s) between the elevation sum and difference beam RSs or RS resources according to or based on those specified or described or defined in the example-D by replacing the third set in the example-D with the set A and the fourth set in the example-D with the set B.
For another example, for the first set provided by csi-RS-ResourceSet-AzimuthBeam, when/if the n-th entry in/of the first set or the RS or RS resource with the n-th lowest (or highest) RS/resource ID/index in/of the first set corresponds to an azimuth sum beam RS or RS resource, and the (n−1)-th and/or (n+1)-th entry in/of the first set or the RS(s) or RS resource(s) with the (n−1)-th and/or (n+1)-th lowest (or highest) RS/resource ID(s)/index(es) in/of the first set corresponds to azimuth difference beam RS(s) or RS resource(s), the UE could determine or identify that the azimuth sum beam RS or RS resource here could be associated, mapped or linked to the azimuth difference beam RS(s) or RS resource(s) defined in this example, wherein n∈{1, . . . , N} and N represents the total number of RS(s) or RS resource(s) in the first set. In addition, for the second set provided by csi-RS-ResourceSet-ElevationBeam, when/if the m-th entry in/of the second set or the RS or RS resource with the m-th lowest (or highest) RS/resource ID/index in/of the second set corresponds to an elevation sum beam RS or RS resource, and the (m−1)-th and/or (m+1)-th entry in/of the second set or the RS(s) or RS resource(s) with the (m−1)-th and/or (m+1)-th lowest (or highest) RS/resource ID(s)/index(es) in/of the second set corresponds to elevation difference beam RS(s) or RS resource(s), the UE could determine or identify that the elevation sum beam RS or RS resource here could be associated, mapped or linked to the elevation difference beam RS(s) or RS resource(s) defined in this example, wherein me {1, . . . , M} and M represents the total number of RS(s) or RS resource(s) in the second set.
For another example, for the first set provided by csi-RS-ResourceSet-AzimuthBeam, when/if the n-th entry in/of the first set or the RS or RS resource with the n-th lowest (or highest) RS/resource ID/index in/of the first set corresponds to an azimuth difference beam RS or RS resource, and the (n−1)-th and/or (n+1)-th entry in/of the first set or the RS(s) or RS resource(s) with the (n−1)-th and/or (n+1)-th lowest (or highest) RS/resource ID(s)/index(es) in/of the first set corresponds to azimuth sum beam RS(s) or RS resource(s), the UE could determine or identify that the azimuth difference beam RS or RS resource here could be associated, mapped or linked to the azimuth sum beam RS(s) or RS resource(s) defined in this example, wherein n∈{1, . . . , N} and N represents the total number of RS(s) or RS resource(s) in the first set. In addition, for the second set provided by csi-RS-ResourceSet-ElevationBeam, when/if the m-th entry in/of the second set or the RS or RS resource with the m-th lowest (or highest) RS/resource ID/index in/of the second set corresponds to an elevation difference beam RS or RS resource, and the (m−1)-th and/or (m+1)-th entry in/of the second set or the RS(s) or RS resource(s) with the (m−1)-th and/or (m+1)-th lowest (or highest) RS/resource ID(s)/index(es) in/of the second set corresponds to elevation sum beam RS(s) or RS resource(s), the UE could determine or identify that the elevation difference beam RS or RS resource here could be associated, mapped or linked to the elevation sum beam RS(s) or RS resource(s) defined in this example, wherein me {1, . . . , M} and M represents the total number of RS(s) or RS resource(s) in the second set.

For this design example, when/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) corresponds to a sum (or difference) beam RS(s) or RS resource(s) according to or following those specified/defined herein in the present disclosure:
the UE could identify or determine, based on the association(s), mapping(s) or linkage(s) defined/specified herein in the present disclosure, a difference (or sum) beam RS(s) or RS resource(s) associated, mapped or linked to the sum (or difference) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure,
and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) corresponds to a difference (or sum) beam RS(s) or RS resource(s) as specified/defined herein in the present disclosure:
the UE could identify or determine, based on the association(s), mapping(s) or linkage(s) defined/specified herein in the present disclosure, a sum (or difference) beam RS(s) or RS resource(s) associated, mapped or linked to the difference (or sum) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure.

According to or following those specified/defined herein in the present disclosure, a RS or RS resource (e.g., in terms/form of the corresponding RS/resource ID/index) could be configured or provided in two resource sets; in one example, the two resource sets could respectively correspond to a first set (or an azimuth sum beam RS or RS resource set) and a third set (or an elevation sum beam RS or RS resource set); in another example, the two resource sets could respectively correspond to a second set (or an azimuth difference beam RS or RS resource set) and a fourth set (or an elevation difference beam RS or RS resource set).

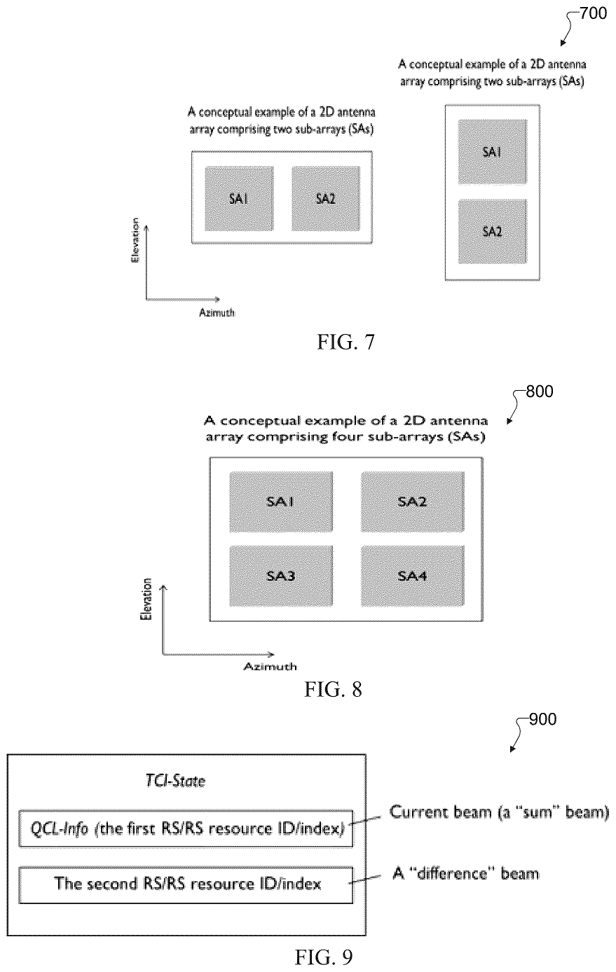

FIG. 7 illustrates an example of a two-dimensional antenna array structure 700 according to embodiments of the present disclosure. The example of a two-dimensional antenna array structure 700 shown in FIG. 7 is for illustration only and other embodiments can be used without departing from the scope of the present disclosure.

Consider 2D antenna array structures as illustrated in FIG. 7, wherein a 2D antenna array could comprise two sub-arrays (SAs) each comprising a half of the total number of antenna elements. Each of the two SAs could generate or probe (azimuth/elevation) sum or difference beams (sum or difference beam RSs or RS resources). For instance,
Array-BP Setting-1a: SA1 could generate or probe (azimuth/elevation) sum beams or sum beam RSs/RS resources as specified/defined herein in the present disclosure, and SA2 could generate or probe (azimuth/elevation) difference beams or difference beam RSs/RS resources as specified/defined herein in the present disclosure
Array-BP Setting-1b: SA1 could generate or probe (azimuth/elevation) difference beams or difference beam RSs/RS resources as specified/defined herein in the present disclosure, and SA2 could generate or probe (azimuth/elevation) sum beams or sum beam RSs/RS resources as specified/defined herein in the present disclosure

FIG. 8 illustrates another example of a two-dimensional antenna array structure 800 according to embodiments of the present disclosure. The example of a two-dimensional antenna array structure 800 shown in FIG. 8 is for illustration only and other embodiments can be used without departing from the scope of the present disclosure.

Consider a 2D antenna array structure as illustrated in FIG. 8, wherein the 2D antenna array could comprise four sub-arrays (SAs) each comprising a quarter of the total number of antenna elements. Each of the four SAs could generate or probe (azimuth/elevation) sum or difference beams (sum or difference beam RSs or RS resources). For instance,
Array-BP Setting-2a: SA1/SA2 could generate or probe (azimuth/elevation) sum beams or sum beam RSs/RS resources as specified/defined herein in the present disclosure, and SA3/SA4 could generate or probe (azimuth/elevation) difference beams or difference beam RSs/RS resources as specified/defined herein in the present disclosure
Array-BP Setting-2b: SA1/SA3 could generate or probe (azimuth/elevation) sum beams or sum beam RSs/RS resources as specified/defined herein in the present disclosure, and SA2/SA4 could generate or probe (azimuth/elevation) difference beams or difference beam RSs/RS resources as specified/defined herein in the present disclosure
Array-BP Setting-2c: SA1/SA4 could generate or probe (azimuth/elevation) sum beams or sum beam RSs/RS resources as specified/defined herein in the present disclosure, and SA2/SA3 could generate or probe (azimuth/elevation) difference beams or difference beam RSs/RS resources as specified/defined herein in the present disclosure
Array-BP Setting-3a: SA1/SA2 could generate or probe (azimuth/elevation) difference beams or difference beam RSs/RS resources as specified/defined herein in the present disclosure, and SA3/SA4 could generate or probe (azimuth/elevation) sum beams or sum beam RSs/RS resources as specified/defined herein in the present disclosure
Array-BP Setting-3b: SA1/SA3 could generate or probe (azimuth/elevation) difference beams or difference beam RSs/RS resources as specified/defined herein in the present disclosure, and SA2/SA4 could generate or probe (azimuth/elevation) sum beams or sum beam RSs/RS resources as specified/defined herein in the present disclosure
Array-BP Setting-3a: SA1/SA4 could generate or probe (azimuth/elevation) difference beams or difference beam RSs/RS resources as specified/defined herein in the present disclosure, and SA2/SA3 could generate or probe (azimuth/elevation) sum beams or sum beam RSs/RS resources as specified/defined herein in the present disclosure

The UE could determine or identify one or more of the aforementioned Array-BP settings according to or based on: (1) fixed value(s)/rule(s) in system specification(s) and/or per RRC (re-) configuration, (2) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection or decision, which could be further sent or transmitted to the network via various UL channels/signals such as CSI/beam report and/or UE's capability signaling(s). For instance, the UE could be provided or configured by the network e.g. via higher layer RRC signaling(s)/parameter(s) CSI-ReportConfig and/or CSI-ResourceConfig one or more indicators (e.g., bitmap(s)) to indicate or provide or configure the one or more of the aforementioned Array-BP settings. Furthermore, for the aforementioned Array-BP setting(s), according to or following those specified herein in the present disclosure,
In one example, the UE could be provided or configured or indicated by the network, e.g., via higher layer RRC signalling(s)/parameter(s) e.g. CSI-ReportConfig and/or CSI-ResourceConfig and/or MAC CE command(s) and/or dynamic DCI based L1 signaling(s) based on or according to a corresponding UE's capability or capability signaling, S1 (e.g., S1>1 or S1≥1) sets of RSs or RS resources with each set comprising one or more (azimuth/elevation) sum beam RSs or RS resources as specified/defined herein in the present disclosure—e.g., in terms/form of the corresponding RS/resource IDs/indexes- and one or more (azimuth/elevation) difference beam RSs or RS resources as specified/defined herein in the present disclosure—e.g., in terms/form of the corresponding RS/resource IDs/indexes-associated, mapped or linked to one or more SAs. The UE could receive from the network, e.g., via higher layer RRC signalling(s)/parameter(s) e.g. CSI-ReportConfig and/or CSI-ResourceConfig and/or MAC CE command(s) and/or dynamic DCI based L1 signaling(s) based on or according to a corresponding UE's capability or capability signalling, one or more indicators to indicate or provide which (one or more) of the S1 sets to use or apply for determining (azimuth/elevation) sum and difference beams (or sum and difference beam RSs or RS resources), and therefore the corresponding (azimuth/elevation) sum-difference function(s), and obtain the corresponding channel (azimuth/elevation) angle estimation result(s). For instance, the one or more indicators could correspond to or could be in form of a bitmap e.g. of length S1 with each entry/bit position of the bitmap corresponding or associated to an aforementioned set (out of the S1 sets). In this case, when/if an entry/bit position of the bitmap is set to ‘1’ (or ‘0’), the UE could determine or identify that the set of RSs or RS resources—out of the S1 sets—could be used or applied for determining (azimuth/elevation) sum and difference beams (or sum and difference beam RSs or RS resources), and therefore the corresponding (azimuth/elevation) sum-difference function(s), and obtain the corresponding channel (azimuth/elevation) angle estimation result(s). The one or more indicators could correspond to higher layer parameter(s) provided or configured in/via/by higher layer RRC signalling(s)/parameter(s) such as CSI-ReportConfig and/or CSI-ResourceConfig. Alternatively, the one or more indicators could be indicated by one or more new/dedicated DCI fields or repurposing one or more codepoints of one or more existing DCI fields in one or more (downlink/uplink) DCI formats. Furthermore, for a (determined or identified) set—out of the S1 sets, the UE could further determine or identical association(s), mapping(s) and/or linkage(s) between the (azimuth/elevation) sum beam RS(s) or RS resource(s) and the (azimuth/elevation) difference beam RS(s) or RS resource(s) configured/provided therein according to or following those specified herein (e.g., those discussed or specified in the example-E) in the present disclosure.
In another example, the UE could be provided or configured or indicated by the network, e.g., via higher layer RRC signalling(s)/parameter(s) e.g. CSI-ReportConfig and/or CSI-ResourceConfig and/or MAC CE command(s) and/or dynamic DCI based L1 signaling(s) based on or according to a corresponding UE's capability or capability signaling, S2 (e.g., S2>1 or S2≥1) sets of RSs or RS resources with each set comprising one or more (azimuth/elevation) sum beam RSs or RS resources as specified/defined herein in the present disclosure—e.g., in terms/form of the corresponding RS/resource IDs/indexes, and S3 (e.g., S3>1 or S3≥1) sets of RSs or RS resources with each set comprising one or more (azimuth/elevation) difference beam RSs or RS resources as specified/defined herein in the present disclosure—e.g., in terms/form of the corresponding RS/resource IDs/indexes. Each of the S2 (or S3) sets could be associated, mapped or linked to one or more SAs.
   The UE could receive from the network, e.g., via higher layer RRC signalling(s)/parameter(s) e.g. CSI-ReportConfig and/or CSI-ResourceConfig and/or MAC CE command(s) and/or dynamic DCI based L1 signaling(s) based on or according to a corresponding UE's capability or capability signalling, one or more first indicators to indicate or provide which (one or more) of the S2 sets to use or apply for determining (azimuth/elevation) sum beams (or sum beam RSs or RS resources); the one or more first indicators could correspond to higher layer parameter(s) provided or configured in/via/by higher layer RRC signalling(s)/parameter(s) such as CSI-ReportConfig and/or CSI-ResourceConfig. Alternatively, the one or more first indicators could be indicated by one or more new/dedicated DCI fields or repurposing one or more codepoints of one or more existing DCI fields in one or more (downlink/uplink) DCI formats.
   The UE could receive from the network, e.g., via higher layer RRC signalling(s)/parameter(s) e.g. CSI-ReportConfig and/or CSI-ResourceConfig and/or MAC CE command(s) and/or dynamic DCI based L1 signaling(s) based on or according to a corresponding UE's capability or capability signalling, one or more second indicators to indicate or provide which (one or more) of the S3 sets to use or apply for determining (azimuth/elevation) difference beams (or difference beam RSs or RS resources); the one or more second indicators could correspond to higher layer parameter(s) provided or configured in/via/by higher layer RRC signalling(s)/parameter(s) such as CSI-ReportConfig and/or CSI-ResourceConfig. Alternatively, the one or more second indicators could be indicated by one or more new/dedicated DCI fields or repurposing one or more codepoints of one or more existing DCI fields in one or more (downlink/uplink) DCI formats.

For this design example, the one or more first indicators could be the same as or identical to the one or more second indicators. In addition, after the UE has determined or identified the (azimuth/elevation) sum and difference beams or beam RSs/RS resources according to or based on those specified herein in the present disclosure, the UE could then determine or identify the corresponding (azimuth/elevation) sum-difference function(s), and obtain the corresponding channel (azimuth/elevation) angle estimation result(s).

### According to or Following Those Specified or Defined Herein in the Present Disclosure,

when/if the UE is provided or configured by the network a set of RSs or RS resources comprising both sum beam RS(s) or RS resource(s) and difference RS(s) or RS resource(s), the UE could determine or identify which of the RSs or RS resources in the set corresponding to sum beam RS(s) or RS resource(s), and/or which of the RSs or RS resources in the set corresponding to difference beam RS(s) or RS resource(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS(s) or RS resource(s) in the set could correspond to sum beam RS(s) or RS resource(s), and the rest of the RS(s) or RS resource(s) in the set could correspond to difference beam RS(s) or RS resource(s), or vice versa.
   For another example, the RS(s) or RS resource(s) with odd (or even) resource ID(s)/index(es) in the set could correspond to sum beam RS(s) or RS resource(s), and the RS(s) or RS resource(s) with even (or odd) resource ID(s)/index(es) in the set could correspond to difference beam RS(s) or RS resource(s).
   For another example, the UE could be provided or configured by the network e.g. via higher layer RRC signaling(s)/parameter(s) CSI-ReportConfig and/or CSI-ResourceConfig a bitmap associated/corresponding/specific to the set with each entry/bit position of the bitmap corresponding to a RS or RS resource—e.g., in terms/form of its RS/resource ID/index—in the set. In this case, when/if an entry/bit position of/in the bitmap is set to ‘1’ (or ‘0’), the RS or RS resource corresponding to the entry/bit position could correspond to a sum beam RS or RS resource, and when/if an entry/bit position of/in the bitmap is set to ‘0’ (or ‘1’), the RS or RS resource corresponding to the entry/bit position could correspond to a difference beam RS or RS resource.
   For another example, higher layer parameter(s)/signaling(s) e.g. NZP-CSI-RS-Resource that provides or configures a RS or RS resource in the set could contain, comprise, include, configure or provide an indicator; when/if the indicator is set to ‘1’ (or ‘0’) or ‘sumBeam’, the RS or RS resource could correspond to a sum beam RS or RS resource as specified or defined herein in the present disclosure, and when/if the indicator is set to ‘0’ (or ‘1’) or ‘diffBeam’, the RS or RS resource could correspond to a difference beam RS or RS resource as specified or defined herein in the present disclosure.
when/if the UE is provided or configured by the network one or more sets of RSs or RS resources—denoted by RS or RS resource set(s) herein—comprising both one or more sets of sum beam RS(s) or RS resource(s) denoted by sum beam RS or RS resource set(s) herein and one or more sets of difference RS(s) or RS resource(s) denoted by difference beam RS or RS resource set(s) herein, the UE could determine or identify which of the RS or RS resource set(s) corresponding to sum beam RS or RS resource set(s), and/or which of the RS or RS resource set(s) corresponding to difference beam RS or RS resource set(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS or RS resource set(s) could correspond to sum beam RS or RS resource set(s), and the rest of the RS or RS resource set(s) could correspond to difference beam RS or RS resource set(s), or vice versa.
   For another example, the RS or RS resource set(s) with odd (or even) resource set ID(s)/index(es) could correspond to sum beam RS or RS resource set(s), and the RS or RS resource set(s) with even (or odd) resource set ID(s)/index(es) could correspond to difference beam RS or RS resource set(s).
   For another example, the UE could be provided or configured by the network e.g. via higher layer RRC signaling(s)/parameter(s) CSI-ReportConfig and/or CSI-ResourceConfig a bitmap with each entry/bit position of the bitmap corresponding to a RS or RS resource set. In this case, when/if an entry/bit position of/in the bitmap is set to ‘1’ (or ‘0’), the RS or RS resource set corresponding to the entry/bit position could correspond to a sum beam RS or RS resource set, and when/if an entry/bit position of/in the bitmap is set to ‘0’ (or ‘1’), the RS or RS resource set corresponding to the entry/bit position could correspond to a difference beam RS or RS resource set.
   For another example, higher layer parameter(s)/signaling(s) e.g. NZP-CSI-RS-ResourceSet that provides or configures a RS or RS resource set could contain, comprise, include, configure or provide an indicator; when/if the indicator is set to ‘1’ (or ‘0’) or ‘sumBeam’, the RS or RS resource set could correspond to a sum beam RS or RS resource set as specified or defined herein in the present disclosure, and when/if the indicator is set to ‘0’ (or ‘1’) or ‘diffBeam’, the RS or RS resource set could correspond to a difference beam RS or RS resource set as specified or defined herein in the present disclosure.

### According to or Following Those Specified or Defined Herein in the Present Disclosure,

when/if the UE is provided or configured by the network a set of RSs or RS resources comprising both (elevation/azimuth) sum beam RS(s) or RS resource(s) and (elevation/azimuth) difference RS(s) or RS resource(s), the UE could determine or identify which of the RSs or RS resources in the set corresponding to sum beam RS(s) or RS resource(s), and/or which of the RSs or RS resources in the set corresponding to difference beam RS(s) or RS resource(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS(s) or RS resource(s) in the set could correspond to (azimuth/elevation) sum beam RS(s) or RS resource(s), and the rest of the RS(s) or RS resource(s) in the set could correspond to (azimuth/elevation) difference beam RS(s) or RS resource(s), or vice versa.
   For another example, the RS(s) or RS resource(s) with odd (or even) resource ID(s)/index(es) in the set could correspond to (azimuth/elevation) sum beam RS(s) or RS resource(s), and the RS(s) or RS resource(s) with even (or odd) resource ID(s)/index(es) in the set could correspond to (azimuth/elevation) difference beam RS(s) or RS resource(s).
   For another example, the UE could be provided or configured by the network e.g. via higher layer RRC signaling(s)/parameter(s) CSI-ReportConfig and/or CSI-ResourceConfig a bitmap associated/corresponding/specific to the set with each entry/bit position of the bitmap corresponding to a RS or RS resource—e.g., in terms/form of its RS/resource ID/index—in the set. In this case, when/if an entry/bit position of/in the bitmap is set to ‘1’ (or ‘0’), the RS or RS resource corresponding to the entry/bit position could correspond to a (azimuth/elevation) sum beam RS or RS resource, and when/if an entry/bit position of/in the bitmap is set to ‘0’ (or ‘1’), the RS or RS resource corresponding to the entry/bit position could correspond to a (azimuth/elevation) difference beam RS or RS resource.
   For another example, higher layer parameter(s)/signaling(s) e.g. NZP-CSI-RS-Resource that provides or configures a RS or RS resource in the set could contain, comprise, include, configure or provide an indicator; when/if the indicator is set to ‘1’ (or ‘0’) or ‘sumBeam’, the RS or RS resource could correspond to a (elevation/azimuth) sum beam RS or RS resource as specified or defined herein in the present disclosure, and when/if the indicator is set to ‘0’ (or ‘1’) or ‘diffBeam’, the RS or RS resource could correspond to a (azimuth/elevation) difference beam RS or RS resource as specified or defined herein in the present disclosure.
when/if the UE is provided or configured by the network a set of RSs or RS resources comprising both (sum/difference) azimuth beam RS(s) or RS resource(s) and (sum/difference) elevation beam RS(s) or RS resource(s), the UE could determine or identify which of the RSs or RS resources in the set corresponding to azimuth beam RS(s) or RS resource(s), and/or which of the RSs or RS resources in the set corresponding to elevation beam RS(s) or RS resource(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS(s) or RS resource(s) in the set could correspond to (sum/difference) azimuth beam RS(s) or RS resource(s), and the rest of the RS(s) or RS resource(s) in the set could correspond to (sum/difference) elevation beam RS(s) or RS resource(s), or vice versa.
   For another example, the RS(s) or RS resource(s) with odd (or even) resource ID(s)/index(es) in the set could correspond to (sum/difference) azimuth beam RS(s) or RS resource(s), and the RS(s) or RS resource(s) with even (or odd) resource ID(s)/index(es) in the set could correspond to (sum/difference) elevation beam RS(s) or RS resource(s).
   For another example, the UE could be provided or configured by the network e.g. via higher layer RRC signaling(s)/parameter(s) CSI-ReportConfig and/or CSI-ResourceConfig a bitmap associated/corresponding/specific to the set with each entry/bit position of the bitmap corresponding to a RS or RS resource—e.g., in terms/form of its RS/resource ID/index—in the set. In this case, when/if an entry/bit position of/in the bitmap is set to ‘1’ (or ‘0’), the RS or RS resource corresponding to the entry/bit position could correspond to a (sum/difference) azimuth beam RS or RS resource, and when/if an entry/bit position of/in the bitmap is set to ‘0’ (or ‘1’), the RS or RS resource corresponding to the entry/bit position could correspond to a (sum/difference) elevation beam RS or RS resource.
   For another example, higher layer parameter(s)/signaling(s) e.g. NZP-CSI-RS-Resource that provides or configures a RS or RS resource in the set could contain, comprise, include, configure or provide an indicator; when/if the indicator is set to ‘1’ (or ‘0’) or ‘azimuthBeam’, the RS or RS resource could correspond to a (sum/difference) azimuth beam RS or RS resource as specified or defined herein in the present disclosure, and when/if the indicator is set to ‘0’ (or ‘1’) or ‘elevationBeam’, the RS or RS resource could correspond to a (sum/difference) elevation beam RS or RS resource as specified or defined herein in the present disclosure.
when/if the UE is provided or configured by the network one or more sets of RSs or RS resources—denoted by RS or RS resource set(s) herein—comprising both one or more sets of (elevation/azimuth) sum beam RS(s) or RS resource(s) denoted by (azimuth/elevation) sum beam RS or RS resource set(s) herein and one or more sets of (elevation/azimuth) difference RS(s) or RS resource(s) denoted by (azimuth/elevation) difference beam RS or RS resource set(s) herein, the UE could determine or identify which of the RS or RS resource set(s) corresponding to sum beam RS or RS resource set(s), and/or which of the RS or RS resource set(s) corresponding to difference beam RS or RS resource set(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS or RS resource set(s) could correspond to (azimuth/elevation) sum beam RS or RS resource set(s), and the rest of the RS or RS resource set(s) could correspond to (azimuth/elevation) difference beam RS or RS resource set(s), or vice versa.
   For another example, the RS or RS resource set(s) with odd (or even) resource set ID(s)/index(es) could correspond to (azimuth/elevation) sum beam RS or RS resource set(s), and the RS or RS resource set(s) with even (or odd) resource set ID(s)/index(es) could correspond to (azimuth/elevation) difference beam RS or RS resource set(s).
   For another example, the UE could be provided or configured by the network e.g. via higher layer RRC signaling(s)/parameter(s) CSI-ReportConfig and/or CSI-ResourceConfig a bitmap with each entry/bit position of the bitmap corresponding to a RS or RS resource set. In this case, when/if an entry/bit position of/in the bitmap is set to ‘1’ (or ‘0’), the RS or RS resource set corresponding to the entry/bit position could correspond to a (azimuth/elevation) sum beam RS or RS resource set, and when/if an entry/bit position of/in the bitmap is set to ‘0’ (or ‘1’), the RS or RS resource set corresponding to the entry/bit position could correspond to a (azimuth/elevation) difference beam RS or RS resource set.
   For another example, higher layer parameter(s)/signaling(s) e.g. NZP-CSI-RS-ResourceSet that provides or configures a RS or RS resource set could contain, comprise, include, configure or provide an indicator; when/if the indicator is set to ‘1’ (or ‘0’) or ‘sumBeam’, the RS or RS resource set could correspond to a (azimuth/elevation) sum beam RS or RS resource set as specified or defined herein in the present disclosure, and when/if the indicator is set to ‘0’ (or ‘1’) or ‘diffBeam’, the RS or RS resource set could correspond to a (azimuth/elevation) difference beam RS or RS resource set as specified or defined herein in the present disclosure.
when/if the UE is provided or configured by the network one or more sets of RSs or RS resources—denoted by RS or RS resource set(s) herein—comprising both one or more sets of (sum/difference) azimuth beam RS(s) or RS resource(s) denoted by (sum/difference) azimuth beam RS or RS resource set(s) herein and one or more sets of (sum/difference) elevation RS(s) or RS resource(s) denoted by (sum/difference) elevation beam RS or RS resource set(s) herein, the UE could determine or identify which of the RS or RS resource set(s) corresponding to azimuth beam RS or RS resource set(s), and/or which of the RS or RS resource set(s) corresponding to elevation beam RS or RS resource set(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS or RS resource set(s) could correspond to (sum/difference) azimuth beam RS or RS resource set(s), and the rest of the RS or RS resource set(s) could correspond to (sum/difference) elevation beam RS or RS resource set(s), or vice versa.
   For another example, the RS or RS resource set(s) with odd (or even) resource set ID(s)/index(es) could correspond to (sum/difference) azimuth beam RS or RS resource set(s), and the RS or RS resource set(s) with even (or odd) resource set ID(s)/index(es) could correspond to (sum/difference) elevation beam RS or RS resource set(s).
   For another example, the UE could be provided or configured by the network e.g. via higher layer RRC signaling(s)/parameter(s) CSI-ReportConfig and/or CSI-ResourceConfig a bitmap with each entry/bit position of the bitmap corresponding to a RS or RS resource set. In this case, when/if an entry/bit position of/in the bitmap is set to ‘1’ (or ‘0’), the RS or RS resource set corresponding to the entry/bit position could correspond to a (sum/difference) azimuth beam RS or RS resource set, and when/if an entry/bit position of/in the bitmap is set to ‘0’ (or ‘1’), the RS or RS resource set corresponding to the entry/bit position could correspond to a (sum/difference) elevation beam RS or RS resource set.
   For another example, higher layer parameter(s)/signaling(s) e.g. NZP-CSI-RS-ResourceSet that provides or configures a RS or RS resource set could contain, comprise, include, configure or provide an indicator; when/if the indicator is set to ‘1’ (or ‘0’) or ‘azimuthBeam’, the RS or RS resource set could correspond to a (sum/difference) azimuth beam RS or RS resource set as specified or defined herein in the present disclosure, and when/if the indicator is set to ‘0’ (or ‘1’) or ‘elevationBeam’, the RS or RS resource set could correspond to a (sum/difference) elevation beam RS or RS resource set as specified or defined herein in the present disclosure.

Throughout the present disclosure, a first RS or RS resource could be referred to as or could correspond to a (azimuth/elevation) sum beam RS or RS resource as specified/defined herein in the present disclosure, and a second RS or RS resource could be referred to as or could correspond to a (azimuth/elevation) difference beam RS or RS resource as specified/defined herein in the present disclosure. Throughout the rest of the present disclosure, it is assumed that a/the UE has identified or determined a first RS or RS resource (corresponding to a (azimuth/elevation) sum beam or a (azimuth/elevation) sum beam RS or RS resource) and a second RS or RS resource (corresponding to a (azimuth/elevation) difference beam or a (azimuth/elevation) difference beam RS or RS resource), wherein the second RS or RS resource could be associated, mapped or linked to the first RS or RS resource according to or following those specified herein in the present disclosure.

For Method-1 and/or Method-1A and/or Method-2 and/or Method-2A as specified/defined herein in the present disclosure, a UE could report, in a CSI/beam report or a reporting instance, one or more of:
The aforementioned channel angle estimation results or azimuth angle estimation result(s), which could be quantized to a x-bit value with y-bit step size, wherein the UE could be determine or identify the value(s) of x and/or y according to or based on: (1) fixed value(s) in system specification(s) and/or per RRC (re-)configuration, (2) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection or decision, which could be further sent or transmitted to the network via various UL channels/signals such as CSI/beam report and/or UE's capability signaling(s)
The aforementioned channel elevation angle estimation result(s), which could be quantized to a x′-bit value with y′-bit step size, wherein the UE could be determine or identify the value(s) of x′ and/or y′ according to or based on: (1) fixed value(s) in system specification(s) and/or per RRC (re-)configuration, (2) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection or decision, which could be further sent or transmitted to the network via various UL channels/signals such as CSI/beam report and/or UE's capability signaling(s)
Index of the aforementioned channel azimuth angle estimation result(s) \hat{θ} determined or selected from a set (or codebook) of candidate channel azimuth angle value(s)
Index of the aforementioned channel elevation angle estimation result(s) \hat{⊗} determined or selected from a set (or codebook) of candidate channel elevation angle value(s)
Resource indicator (SSBRI/CRI) of a/the first RS/RS resource and/or a beam metric (L1-RSRP/L1-SINR) corresponding to the first RS/RS resource
Resource indicator (SSBRI/CRI) of a/the second RS/RS resource and/or a beam metric (L1-RSRP/L1-SINR) corresponding to the second RS/RS resource
Channel state information (CSI) report for a/the first RS/RS resource
Channel state information (CSI) report for a/the second RS/RS resource

According to or following those specified/defined herein in the present disclosure, a UE could use or apply or follow those specified/described in Method-1 and/or Method-1A and/or Method-2 and/or Method-2A to perform measurement(s) and/or reporting(s) according to or based on:
Fixed rule(s) and/or event(s) in system specification(s) and/or per RRC (re-)configuration,
   in one example, the beam metric e.g. the measured L1-RSRP for the second RS or RS resource (i.e., the difference beam) is greater than or equal to a first threshold;
   in another example, the beam metric e.g. the measured L1-RSRP for the first RS or RS resource (i.e., the sum beam) is less (or greater) than or equal to a second threshold, and the beam metric e.g. the measured L1-RSRP for the second RS or RS resource (i.e., the difference beam) is greater than or equal to a third threshold;
   in another example, the difference between the beam metric e.g. the measured L1-RSRP for the first RS or RS resource (i.e., the sum beam) and the beam metric e.g. the measured L1-RSRP for the second RS or RS resource (i.e., the difference beam) is less (or greater) than or equal to a fourth threshold, and/or the sum of the beam metric e.g. the measured L1-RSRP for the first RS or RS resource (i.e., the sum beam) and the beam metric e.g. the measured L1-RSRP for the second RS or RS resource (i.e., the difference beam) is greater (or less) than or equal to a fifth threshold.

The UE could determine or identify the first, second, third, fourth and/or fifth threshold(s) according to or based on: (i) fixed value(s) in system specification(s) and/or per RRC (re-) configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling,
   in one example, a pair of the first and second RSs or RS resources as specified/defined herein in the present disclosure are configured or provided
   in another example, the UE is configured or provided by the network, e.g., via higher layer RRC signaling(s)/parameter(s), a higher layer parameter sumdiffBM (e.g. set to ‘enabled’)
   in another example, the UE is configured or provided by the network, e.g., in/via/by higher layer RRC signaling(s)/parameter(s) e.g. in CSI-ReportConfig, the higher layer parameter reportQuantity set to ‘sumdiffBeam’.
UE's autonomous determination or selection or decision based on or according to one or more of:
   in one example, the beam metric e.g. the measured L1-RSRP for the second RS or RS resource (i.e., the difference beam) is greater than or equal to a first threshold;
   in another example, the beam metric e.g. the measured L1-RSRP for the first RS or RS resource (i.e., the sum beam) is less (or greater) than or equal to a second threshold, and the beam metric e.g. the measured L1-RSRP for the second RS or RS resource (i.e., the difference beam) is greater than or equal to a third threshold;
   in another example, the difference between the beam metric e.g. the measured L1-RSRP for the first RS or RS resource (i.e., the sum beam) and the beam metric e.g. the measured L1-RSRP for the second RS or RS resource (i.e., the difference beam) is less (or greater) than or equal to a fourth threshold, and/or the sum of the beam metric e.g. the measured L1-RSRP for the first RS or RS resource (i.e., the sum beam) and the beam metric e.g. the measured L1-RSRP for the second RS or RS resource (i.e., the difference beam) is greater (or less) than or equal to a fifth threshold,
wherein the UE could determine or identify the first, second, third, fourth and/or fifth threshold(s) according to or based on: (i) fixed value(s) in system specification(s) and/or per RRC (re-) configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s). In this case, the UE's autonomous determination or selection or decision could be further sent or transmitted to the network via various UL channels/signals such as CSI/beam report and/or UE's capability signaling(s). In this case, the corresponding CSI/beam report or reporting instance could also contain, comprise, include, provide or indicate an indicator (e.g., a one-bit indicator set to ‘1’ (or ‘0’)) to indicate that the report quantity(s)/content(s) in the CSI/beam report or the reporting instance is determined or identified by the UE according to the measurement(s) obtained by using, applying or following those specified/described in Method-1 and/or Method-2.

Furthermore, the UE could determine or identify which of the Method-1 and Method-2 to use or apply or follow to perform measurement(s) and/or reporting(s) according to or based on:
Fixed rule(s) and/or event(s) in system specification(s) and/or per RRC (re-)configuration.
The network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling,
   in one example, the UE could use or apply or follow those specified/described in at least Method-1 to perform measurement(s) and/or reporting(s) when/if:
      a pair of the first and second RSs or RS resources as specified/defined in Method-1 are configured or provided, and/or
      the UE is configured or provided by the network, e.g., via higher layer RRC signaling(s)/parameter(s), a higher layer parameter sumdiffBMType set to ‘method-1’ or ‘differentialBeams’ or ‘both’;
   in another example, the UE could use or apply or follow those specified/described in at least Method-2 to perform measurement(s) and/or reporting(s) when/if:
      a pair of the first and second RSs or RS resources as specified/defined in Method-2 are configured or provided, and/or
      the UE is configured or provided by the network, e.g., via higher layer RRC signaling(s)/parameter(s), a higher layer parameter sumdiffBMType set to ‘method-2’ or ‘overlappingBeams’ or ‘both’.
The UE's autonomous determination or selection or decision, which could be further sent or transmitted to the network via various UL channels/signals such as CSI/beam report and/or UE's capability signaling(s). In this case, the corresponding CSI/beam report or reporting instance could also contain, comprise, include, provide or indicate an indicator (e.g., a one-bit indicator that can be set to ‘0’ or ‘1’ or a two-bit indicator that can be set to ‘00’, ‘01’, ‘10’ or ‘11’). In this case,
   When/if the indicator is set to ‘0’ (or ‘1’) or ‘00’ (or ‘01’ or ‘10’ or ‘11’), the report quantity(s)/content(s) in the CSI/beam report or the reporting instance is determined or identified by the UE according to the measurement(s) obtained by using, applying or following those specified/described in at least Method-1, and/or
   When/if the indicator is set to ‘1’ (or ‘0’) or ‘01’ (or ‘00’ or ‘10’ or ‘11’), the report quantity(s)/content(s) in the CSI/beam report or the reporting instance is determined or identified by the UE according to the measurement(s) obtained by using, applying or following those specified/described in at least Method-2, and/or
   When/if the indicator is set to ‘0’ or ‘1’ or ‘10’ or ‘11’ (or ‘00’ or ‘01’), the report quantity(s)/content(s) in the CSI/beam report or the reporting instance is determined or identified by the UE according to the measurement(s) obtained by using, applying or following those specified/described in both Method-1 and Method-2.

For Method-1 and/or Method-1A and/or Method-2 and/or Method-2A as specified/defined herein in the present disclosure, after a UE has sent or transmitted to the network the CSI/beam report according to or following those specified herein in the present disclosure, the UE could expect to receive from the network a corresponding response e.g. (i) X symbol(s)/slot(s)/etc. after a last symbol/slot/etc. of transmission of the CSI/beam report, and/or (ii) within Y symbol(s)/slot(s)/etc. after a last symbol/slot/etc. of transmission of the CSI/beam report, wherein the UE could determine or identify value(s) of X and/or Y according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s). Furthermore, the network's response could be in form of one or more of:
A one-bit ACK/NACK indicator
A TCI state update indicated e.g. via a codepoint of a (unified) TCI state(s) activation/deactivation MAC CE and/or a TCI codepoint of a/the TCI field in a beam indication DCI (e.g., DCI format(s) 1_1/1_2 with or without DL assignment)

When/if the network's response is indicated via a DCI, the network's response could be provided to the UE via a new/dedicated DCI field, or by repurposing one or more codepoints of one or more existing DCI fields in the corresponding DCI format(s).

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

A UE could receive from the network a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs, and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein all of the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, all of the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),

### And/or (2) at Least One TCI Codepoint Activated Therein Composing/Comprising of One of:

Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),

### And Another TCI Codepoint Activated Therein Composing/Comprising of One of:

Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applyIndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH-a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCI-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE is configured with dl-OrJointTCI-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI based MTRP” in frequency range 2, or
If the UE does not report its capability indicating support of “two default beams for S-DCI based MTRP” in frequency range 2 and if the scheduling offset between the reception of the scheduling DCI format 1_0/1_1/1_2 and the scheduled/activated PDSCH reception is equal to or larger than timeDurationForQCL
The UE can be configured by higher layer parameter applyIndicatedTCIState to indicate whether the first, the second, or both of the indicated TCI-state(s) is/are applied to PDSCH reception scheduled or activated by DCI format 1_0. The UE can be configured with applyIndicatedTCIState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type0/0A/2 CSS on CORESET #0.
If the UE is not configured with applyIndicatedTCIState, the first indicated TCI-state is applied to PDSCH reception scheduled or activated by DCI format 1_0.
When the UE is configured with tciSelection-PresentInDCI jointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
If the DCI format 1_1/1_2 indicates codepoint “00” for the TCI selection field (or equivalently, the second indicator as specified herein in the present disclosure), the UE shall apply the first one of two indicated joint/DL TCI states to all PDSCH DM-RS port(s) of corresponding PDSCH transmission occasions(s) scheduled or activated by the DCI format 1_1/1_2.
If the DCI format 1_1/1_2 indicates codepoint “01” for the TCI selection field (or equivalently, the second indicator as specified herein in the present disclosure), the UE shall apply the second one of two indicated joint/DL TCI states to all PDSCH DM-RS port(s) of corresponding PDSCH transmission occasion(s) scheduled or activated by the DCI format 1_1/1_2.
If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH-a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

FIG. 9 illustrates an example of using a TCI state to indicate a pair of RSs for beam tracking 900 according to embodiments of the present disclosure. The example of using a TCI state to indicate a pair of RSs for beam tracking 900 shown in FIG. 9 is for illustration only and other embodiments can be used without departing from the scope of the present disclosure.

Throughout the rest of the present disclosure, or for all the design examples/procedures throughout the rest of the present disclosure, a sum beam or a sum beam RS/RS resource (e.g., a/the first, second and/or third RS(s) or RS resource(s) used throughout the rest of the present disclosure), and a difference beam or a difference beam RS/RS resource (e.g., a/the first, second and/or third RS(s) or RS resource(s) used throughout the rest of the present disclosure) are defined for an azimuth or elevation domain. Or, throughout the rest of the present disclosure, or for all the design examples/procedures throughout the rest of the present disclosure, the UE could determine or identify a/the sum beam RS/RS resource (e.g., a/the first, second and/or third RS(s) or RS resource(s) used throughout the rest of the present disclosure) and a/the difference beam RS/RS resource (e.g., a/the first, second and/or third RS(s) or RS resource(s) used throughout the rest of the present disclosure) on a basis of an azimuth or elevation domain. Or, throughout the rest of the present disclosure, all the design examples/procedures including definition(s) of a/the sum beam or sum beam RS/RS resource (e.g., a/the first, second and/or third RS(s) or RS resource(s) used throughout the rest of the present disclosure) and a/the difference beam or difference beam RS/RS resource (e.g., a/the first, second and/or third RS(s) or RS resource(s) used throughout the rest of the present disclosure) are illustrated, specified or discussed per or on a basis of an azimuth/elevation domain.

In one embodiment, a UE could use or apply a first TCI state—e.g., a first RS or RS resource associated with, e.g., indicated in/by, the first TCI state—to determine or identify spatial domain filter(s) for transmitting various uplink channel(s) and/or signal(s) including PUCCH(s), PUSCH(s) and/or SRS(s), and/or for receiving various downlink channel(s) and/or signal(s) including PDCCH(s), PDSCH(s) and/or CSI-RS(s) according to or following those specified herein in the present disclosure. In particular, the first RS or RS resource could correspond to:
Scheme-1: a/the CSI-RS resource/resource configuration—e.g. served as a/the QCL source RS/RS resource—indicated in/by the first TCI state, wherein the CSI-RS resource/resource configuration could be provided in a CSI resource set configured with ‘repetition’ set to ‘on’, and/or a CSI resource set configured with ‘trs-Info’
Scheme-2: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the first TCI state

The UE could determine or identify the first RS or RS resource following Scheme-1 or Scheme-2 based on or according to network's configuration(s)/indication(s)—e.g., Scheme-1 or Scheme-2 is enabled for determining or identifying the first RS or RS resource—via higher layer RRC signaling(s)/parameter(s) and/or MAC CE command(s) and/or dynamic DCI based L1 signaling(s) according to or based on a corresponding UE's capability or capability signaling. For beam(s) tracking,
In one example, the first TCI state (and therefore, the first RS or RS resource) could be associated to a second RS or RS resource, wherein the second RS or RS resource could be different or separate from the first RS or RS resource; for this design example, the UE could determine or identify the association between the first TCI state (and therefore, the first RS or RS resource) and the second RS or RS resource according to or following one or more of:
   For example, higher layer parameter(s)/signaling(s) e.g. TCI-State that provides or configures the first TCI state could also provide or configure or comprise or include or contain or indicate the second RS or RS resource—e.g., in form/terms of the corresponding RS or RS resource ID/index (one conceptual example is presented in FIG. 8); alternatively, higher layer parameter(s)/signaling(s) e.g. NZP-CSI-RS-Resource that provides or configures the second RS or RS resource could also provide or configure or comprise or include or contain or indicate the first TCI state—e.g., in form/terms of the corresponding TCI state ID/index; optionally, higher layer parameter(s)/signaling(s) e.g. TCI-State that provides or configures the first TCI state could also provide or configure or comprise or include or contain or indicate a first entity ID, and higher layer parameter(s)/signaling(s) e.g. NZP-CSI-RS-Resource that provides or configures the second RS or RS resource could also provide or configure or comprise or include or contain or indicate a second entity ID, wherein the first and second entity IDs could be identical or same, or could have a/same value.

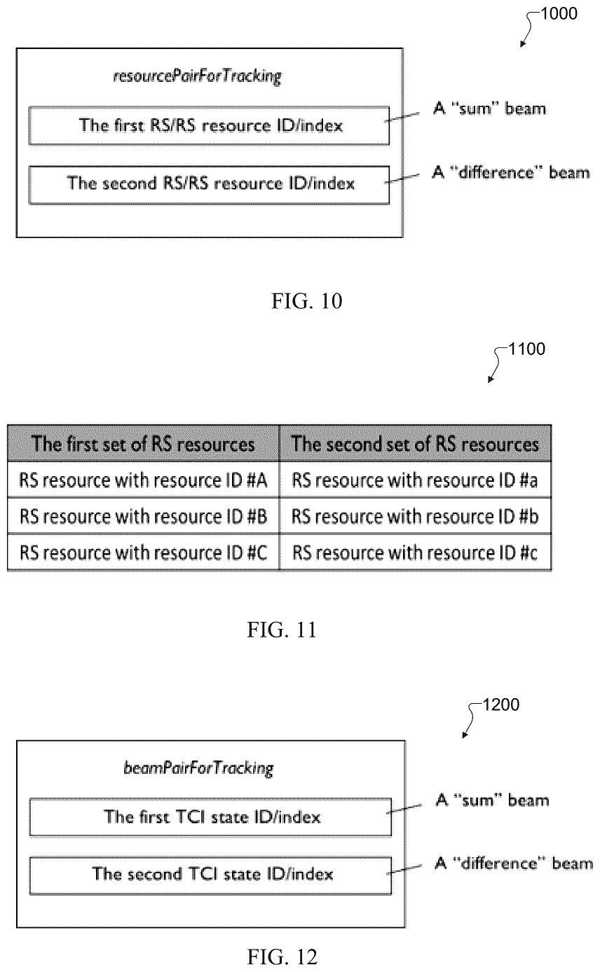

FIG. 10 illustrates an example of indicating a pair of RSs for beam tracking 1000 according to embodiments of the present disclosure. The example of indicating a pair of RSs for beam tracking 1000 as shown in FIG. 10 is for illustration only and other embodiments can be used without departing from the scope of the present disclosure.

FIG. 11 illustrates an example of using a lookup table to characterize the association/mapping relation between RSs/RS resources for beam tracking 1100 according to embodiments of the present disclosure. The example of using a lookup table to characterize the association/mapping relation between RSs/RS resources for beam tracking 1100 as shown in FIG. 11 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, an association/mapping relation between the first and second RSs/RS resources:
   In one example, the first and second RSs/RS resources—e.g., in terms/form of their RS/resource IDs/indexes—could be provided or configured in/as a/the same resource set, resource group, resource pair and/or etc. In FIG. 10, a conceptual example of a resource pair for tracking provided by a higher layer parameter resourcePairForTracking is presented.
   In another example, the first and second RSs/RS resources—e.g., in terms/form of their RS/resource IDs/indexes—could be provided or configured or activated or indicated in/by a/the same higher layer RRC signaling(s)/parameter(s) and/or MAC CE command(s) and/or dynamic DCI based L1 signaling(s).
   In another example, the higher layer parameter(s)/signaling(s) that provides or configures the first RS/RS resource e.g. NZP-CSI-RS-Resource could also provide or configure a first entity ID, and the higher layer parameter(s)/signaling(s) that provides or configures the second RS/RS resource e.g. NZP-CSI-RS-Resource could also provide or configure a second entity ID, wherein the first and second entity IDs could be identical or same, or could have a/same value.
   In another example, the first RS/RS resource e.g. in terms/form of the corresponding RS/RS resource ID/index could be provided or configured in a first list/set/group/pair of RS(s) or RS resource(s) as/corresponding to the k-th entry of/in the first list/set/group/pair, and the second RS/RS resource e.g. in terms/form of the corresponding RS/RS resource ID/index could be provided or configured in a second list/set/group/pair of RS(s) or RS resource(s) as/corresponding to the 1-th entry of/in the second list/set/group/pair, wherein k=1.
   In another example, the higher layer parameter(s)/signaling(s) that provides or configures the first RS/RS resource e.g. NZP-CSI-RS-Resource could also provide or configure the second RS/RS resource e.g. in form/terms of the corresponding RS/resource ID/index.
   In another example, the higher layer parameter(s)/signaling(s) that provides or configures the second RS/RS resource e.g. NZP-CSI-RS-Resource could also provide or configure the first RS/RS resource e.g. in form/terms of the corresponding RS/resource ID/index.
   In another example, the UE could be provided or configured or indicated by the network, e.g., via higher layer RRC signaling(s)/parameter(s) and/or MAC CE command(s) and/or dynamic DCI based L1 signaling(s), a look-up table, wherein the first and second RS or RS resources—e.g., in terms/form of their RS or RS resource IDs/indexes—could correspond to two neighboring entries, or entries of two neighboring rows, or entries of two neighboring columns in the look-up table.
   In another example, the first and second RSs or RS resources—e.g., in terms/form of their RS/resource IDs/indexes—could be provided or configured in/as a/the same resource set; for this design example, the first and second RSs or RS resources could be respectively associated to/with a first and a second entity IDs (e.g., provided or configured in higher layer parameter(s)/signaling(s) that provides or configures the resource set), wherein the first and second entity IDs could be identical or same, or could have a/same value.
   In another example, the UE could be configured or provided by the network, e.g., via/in/by higher layer RRC signaling(s)/parameter(s) CSI-ReportConfig and/or CSI-ResourceConfig, a first RS or RS resource set provided by csi-RS-ResourceSet-SumBeam comprising one or more RSs or RS resources (e.g., in terms/form of their corresponding RS/resource IDs/indexes), and a second RS or RS resource set provided by csi-RS-ResourceSet-DiffBeam comprising one or more RSs or RS resources (e.g., in terms/form of their corresponding RS/resource IDs/indexes). The first and second sets of RSs or RS resources could have the same number of RSs or RS resources configured or provided therein, and each RS or RS resource (e.g., in terms/form of its corresponding RS/resource ID/index) in the first set could be associated, mapped or linked to a RS or RS resource (e.g., in terms/form of its corresponding RS/resource ID/index) in the second set; in this case, the UE could determine or identify the association(s), mapping(s) and/or linkage(s) according to or based on one or more of:
      fixed rule(s) in system specification(s) and/or per RRC (re-)configuration: for instance, the k-th entry (hence the corresponding RS/RS resource or RS/RS resource ID/index) of/in the first set could be associated, mapped or linked to the k-th entry (hence the corresponding RS/RS resource or RS/RS resource ID/index) of/in the second set, wherein k=1, . . . , K, and K represents the total number of RS(s) or RS resource(s)—e.g., in terms/form the corresponding RS/resource ID(s)/index(es) configured/provided in the first (or second) set. Alternatively, the RS/RS resource with the k-th lowest (or highest) RS/resource ID/index-among all the K≥1 RS(s)/RS resource(s) in the first set wherein k=1, . . . , K-configured/provided in the first set could be associated, mapped or linked to the RS/RS resource with the k-th lowest (or highest) RS/resource ID/index-among all the K≥1 RS(s)/RS resource(s) in the second set wherein k=1, . . . , K-configured/provided in the second set. In FIG. 11, a look-up table that characterizes the association, mapping or linkage between the RSs or RS resources in the first and second sets is presented, which can be provided or configured to the UE by the network, e.g., via higher layer RRC signaling(s)/parameter(s) and/or MAC CE command(s) and/or dynamic DCI based L1 signaling(s) based on or according to a corresponding UE's capability or capability signaling. As illustrated in the look-up table, the first set comprises RS resources with resource IDs #A, #B and #C, and the second set comprises RS resources with resource IDs #a, #b and #c; in this case, the RS resources with resource IDs #A, #B and #C in the first set are respectively associated, mapped or linked to the RS resources with resource IDs #a, #b and #c in the second set.
      network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the RS or RS resource in the first set associated/configured with the given RS/RS resource ID/index could be associated, mapped or linked to the RS or RS resource in the second set associated/configured with the (same) given RS/RS resource ID/index.
      UE's autonomous determination or selection, which could be further sent or transmitted to the network via various UL channels/signals such as CSI/beam report and/or UE's capability signaling(s)

For this design example, a RS or RS resource (in terms/form of its corresponding or respective RS/resource ID or index)—e.g., corresponding to the aforementioned first RS or RS resource—in the first set and its associated, mapped or linked RS or RS resource (in terms/form of its corresponding or respective RS/resource ID or index)—e.g., corresponding to the aforementioned second RS or RS resource—in the second set could respectively correspond to a sum beam (or a sum beam RS or RS resource) and a difference beam (or a difference beam RS or RS resource) according to or following those specified/defined herein in the present disclosure, or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned first set, the UE could then determine or identify that the determined or identified RS(s) or RS resource(s) could correspond to a sum (or difference) beam RS(s) or RS resource(s) as specified/defined herein in the present disclosure, and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned second set, the UE could then determine or identify that the determined or identified RS(s) or RS resource(s) could correspond to a difference (or sum) beam RS(s) or RS resource(s) as specified/defined herein in the present disclosure.

In this case, when/if the first RS or RS resource is associated with, e.g. indicated in/by, the first TCI state, the UE could identify or determine, based on or according to the association/mapping relation, the second RS or RS resource.

Furthermore, the second RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.
In another example, the first TCI state (and therefore, the first RS or RS resource) could be associated to a second TCI state, wherein a second RS or RS resource could be associated with, e.g., indicated in/by, the second TCI state, and/or the first TCI state could be different/separate from the second TCI state (e.g., in form/terms of their respective TCI state IDs/indexes), and/or the second RS or RS resource could be different or separate from the first RS or RS resource (e.g., in form/terms of their respective RS/resource IDs/indexes); for this design example, the UE could determine or identify the association between the first TCI state (and therefore, the first RS or RS resource) and the second TCI state (and therefore, the second RS or RS resource) according to or following one or more of:
   For example, higher layer parameter(s)/signaling(s) e.g. TCI-State that provides or configures the first TCI state could also provide or configure or comprise or include or contain or indicate the second TCI state—e.g., in form/terms of the corresponding TCI state ID/index; alternatively, higher layer parameter(s)/signaling(s) e.g. TCI-State that provides or configures the second TCI state could also provide or configure or comprise or include or contain or indicate the first TCI state—e.g., in form/terms of the corresponding TCI state ID/index; optionally, higher layer parameter(s)/signaling(s) e.g. TCI-State that provides or configures the first TCI state could also provide or configure or comprise or include or contain or indicate a first entity ID, and higher layer parameter(s)/signaling(s) e.g. TCI-State that provides or configures the second TCI state could also provide or configure or comprise or include or contain or indicate a second entity ID, wherein the first and second entity IDs could be identical or same, or could have a/same value.

FIG. 12 illustrates an example of indicating a pair of TCI states for beam tracking 1200 according to embodiments of the present disclosure. The example of indicating a pair of TCI states for beam tracking 1200 as shown in FIG. 12 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, an association/mapping relation between the first and second TCI states (and therefore, between the first and second RSs/RS resources):
   In one example, the first and second TCI states—e.g., in terms/form of their TCI state IDs/indexes—could be provided or configured in/as a/the same list/set/pool, group and/or pair of TCI states (or TCI state IDs/indexes). In FIG. 12, a conceptual example of a beam pair for tracking provided by a higher layer parameter beamPairForTracking is presented.
   In another example, the first and second TCI states—e.g., in terms/form of their TCI state IDs/indexes—could be provided or configured or activated or indicated in/by a/the same higher layer RRC signaling(s)/parameter(s) and/or MAC CE command(s) and/or dynamic DCI based L1 signaling(s).
   In another example, the higher layer parameter(s)/signaling(s) that provides or configures the first TCI state e.g. TCI-State could also provide or configure a first entity ID, and the higher layer parameter(s)/signaling(s) that provides or configures the second TCI state e.g. TCI-State could also provide or configure a second entity ID, wherein the first and second entity IDs could be identical or same, or could have a/same value.
   In another example, the first TCI state e.g. in terms/form of the corresponding TCI state ID/index could be provided or configured in a first list/set/pool/group/pair of TCI state(s) or TCI state ID(s)/index(es) as/corresponding to the k-th entry in/of the first list/set/pool/group/pair, and the second TCI state e.g. in terms/form of the corresponding TCI state ID/index could be provided or configured in a second list/set/pool/group/pair of TCI state(s) or TCI state ID(s)/index(es) as/corresponding to the 1-th entry in/of the second list/set/pool/group/pair, wherein k=1.
   In another example, the UE could be provided or configured or indicated by the network, e.g., via higher layer RRC signaling(s)/parameter(s) and/or MAC CE command(s) and/or dynamic DCI based L1 signaling(s), a look-up table, wherein the first and second TCI states—e.g., in terms/form of their TCI state IDs/indexes—could correspond to two neighboring entries, or entries of two neighboring rows, or entries of two neighboring columns in the look-up table.
   In another example, the first and second TCI states—e.g., in terms/form of their TCI state IDs/indexes—could be provided or configured in/as a/the same list/set/pool of TCI states (or TCI state IDs/indexes); for this design example, the first and second TCI states could be respectively associated to/with a first and a second entity IDs (e.g., provided or configured in higher layer parameter(s)/signaling(s) that provides or configures the list/set/pool of TCI states/TCI state IDs/indexes), wherein the first and second entity IDs could be identical or same, or could have a/same value.

In this case, when/if the UE has received or indicated or updated by the network the first TCI state (hence the corresponding/associated first RS or RS resource), the UE could identify or determine, based on or according to the association/mapping relation, the second TCI state (hence the corresponding/associated second RS or RS resource).

In Particular, the Second RS or RS Resource could Correspond to:
Scheme-i: a/the CSI-RS resource/resource configuration—e.g. served as a/the QCL source RS/RS resource—indicated in/by the second TCI state, wherein the CSI-RS resource/resource configuration could be provided in a CSI resource set configured with ‘repetition’ set to ‘on’, and/or a CSI resource set configured with ‘trs-Info’
Scheme-ii: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the second TCI state

The UE could determine or identify the second RS or RS resource following Scheme-i or Scheme-ii based on or according to network's configuration(s)/indication(s)—e.g., Scheme-i or Scheme-ii is enabled for determining or identifying the second RS or RS resource—via higher layer RRC signaling(s)/parameter(s) and/or MAC CE command(s) and/or dynamic DCI based L1 signaling(s) according to or based on a corresponding UE's capability or capability signaling. Alternatively, or optionally, the second RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.

According to or following those specified herein in the present disclosure, the UE could determine or identify the aforementioned first RS or RS resource as a sum beam (or a sum beam RS or RS resource), and the aforementioned second RS or RS resource as a difference beam (or a difference beam RS or RS resource). The UE could then conduct the measurement and/or reporting procedure(s) with respect to or regarding the sum beam (hence the first RS or RS resource) and the difference beam (hence the second RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.

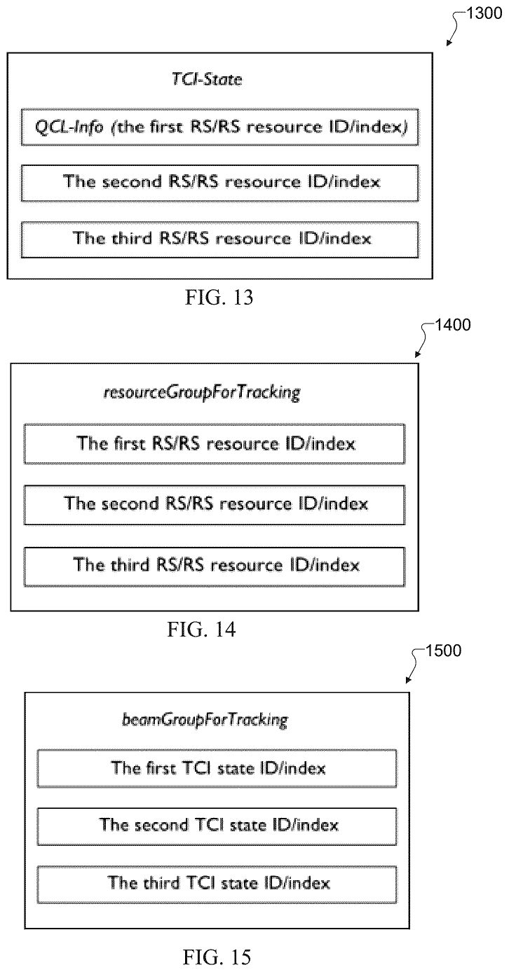

FIG. 13 illustrates an example of using a TCI state to indicate a group of three RSs for beam tracking 1300 according to embodiments of the present disclosure. The example of using a TCI state to indicate a group of three RSs for beam tracking 1300 as shown in FIG. 13 is for illustration only and other embodiments can be used without departing from the scope of the present disclosure.

In one embodiment, a UE could use or apply a first TCI state—e.g., a first RS or RS resource associated with, e.g., indicated in/by, the first TCI state—to determine or identify spatial domain filter(s) for transmitting various uplink channel(s) and/or signal(s) including PUCCH(s), PUSCH(s) and/or SRS(s), and/or for receiving various downlink channel(s) and/or signal(s) including PDCCH(s), PDSCH(s) and/or CSI-RS(s) according to or following those specified herein in the present disclosure. In particular, the first RS or RS resource could correspond to:
Scheme-1: a/the CSI-RS resource/resource configuration—e.g. served as a/the QCL source RS/RS resource—indicated in/by the first TCI state, wherein the CSI-RS resource/resource configuration could be provided in a CSI resource set configured with ‘repetition’ set to ‘on’, and/or a CSI resource set configured with ‘trs-Info’
Scheme-2: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the first TCI state

The UE could determine or identify the first RS or RS resource following Scheme-1 or Scheme-2 based on or according to network's configuration(s)/indication(s)—e.g., Scheme-1 or Scheme-2 is enabled for determining or identifying the first RS or RS resource—via higher layer RRC signaling(s)/parameter(s) and/or MAC CE command(s) and/or dynamic DCI based L1 signaling(s) according to or based on a corresponding UE's capability or capability signaling. For beam(s) tracking,
In one example, the first TCI state (and therefore, the first RS or RS resource) could be associated to a second RS or RS resource and a third RS or RS resource, wherein the third RS or RS resource could be different or separate from the first RS or RS resource and/or the second RS or RS resource; for this design example, the UE could determine or identify the association between the first TCI state (and therefore, the first RS or RS resource), the second RS or RS resource and/or the third RS or RS resource according to or following one or more of:
   For example, higher layer parameter(s)/signaling(s) e.g. TCI-State that provides or configures the first TCI state could also provide or configure or comprise or include or contain or indicate the second RS or RS resource—e.g., in form/terms of the corresponding RS or RS resource ID/index—and/or the third RS or RS resource—e.g., in form/terms of the corresponding RS or RS resource ID/index (one conceptual example is presented in FIG. 10); alternatively, higher layer parameter(s)/signaling(s) e.g. NZP-CSI-RS-Resource that provides or configures the second RS or RS resource could also provide or configure or comprise or include or contain or indicate the first TCI state—e.g., in form/terms of the corresponding TCI state ID/index—and/or the third RS or RS resource—e.g., in form/terms of the corresponding RS or RS resource ID/index, and/or higher layer parameter(s)/signaling(s) e.g. NZP-CSI-RS-Resource that provides or configures the third RS or RS resource could also provide or configure or comprise or include or contain or indicate the first TCI state—e.g., in form/terms of the corresponding TCI state ID/index—and/or the second RS or RS resource—e.g., in form/terms of the corresponding RS or RS resource ID/index; optionally, higher layer parameter(s)/signaling(s) e.g. TCI-State that provides or configures the first TCI state could also provide or configure or comprise or include or contain or indicate a first entity ID, higher layer parameter(s)/signaling(s) e.g. NZP-CSI-RS-Resource that provides or configures the second RS or RS resource could also provide or configure or comprise or include or contain or indicate a second entity ID, and/or higher layer parameter(s)/signaling(s) e.g. NZP-CSI-RS-Resource that provides or configures the third RS or RS resource could also provide or configure or comprise or include or contain or indicate a third entity ID, wherein the first, second and/or third entity IDs could be identical or same, or could have a/same value.

FIG. 14 illustrates an example of indicating a group of three RSs for beam tracking 1400 according to embodiments of the present disclosure. The example of indicating a group of three RSs for beam tracking 1400 as shown in FIG. 14 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, a first association/mapping relation between the first and second RSs/RS resources, a second association/mapping relation between the first and third RSs/RS resources, a third association/mapping relation between the second and third RSs/RS resources, and/or a fourth association/mapping relation between the first, second and third RSs/RS resources:
   In one example, for the fourth association/mapping relation, the first, second and third RSs/RS resources—e.g., in terms/form of their RS/resource IDs/indexes—could be provided or configured in/as a/the same resource set, resource group, resource pair and/or etc. In FIG. 14, a conceptual example of a resource group for tracking provided by a higher layer parameter resourceGroupForTracking is presented, wherein the resource group for tracking characterizes the aforementioned fourth association/mapping relation.
   In another example, for the fourth association/mapping relation, the first, second and third RSs/RS resources—e.g., in terms/form of their RS/resource IDs/indexes—could be provided or configured or activated or indicated in/by a/the same higher layer RRC signaling(s)/parameter(s) and/or MAC CE command(s) and/or dynamic DCI based L1 signaling(s).
   In another example, for the fourth association/mapping relation, the higher layer parameter(s)/signaling(s) that provides or configures the first RS/RS resource e.g. NZP-CSI-RS-Resource could also provide or configure a first entity ID, the higher layer parameter(s)/signaling(s) that provides or configures the second RS/RS resource e.g. NZP-CSI-RS-Resource could also provide or configure a second entity ID, and the higher layer parameter(s)/signaling(s) that provides or configures the third RS/RS resource e.g. NZP-CSI-RS-Resource could also provide or configure a third entity ID, wherein the first, second and third entity IDs could be identical or same, or could have a/same value.
   In another example, for the fourth association/mapping relation, the first RS/RS resource e.g. in terms/form of the corresponding RS/RS resource ID/index could be provided or configured in a first list/set/group/pair of RS(s) or RS resource(s) as/corresponding to the k-th entry of/in the first list/set/group/pair, the second RS/RS resource e.g. in terms/form of the corresponding RS/RS resource ID/index could be provided or configured in a second list/set/group/pair of RS(s) or RS resource(s) as/corresponding to the 1-th entry of/in the second list/set/group/pair, and the third RS/RS resource e.g. in terms/form of the corresponding RS/RS resource ID/index could be provided or configured in a third list/set/group/pair of RS(s) or RS resource(s) as/corresponding to the m-th entry of/in the third list/set/group/pair wherein k=1=m.
   In another example, for the fourth association/mapping relation, the higher layer parameter(s)/signaling(s) that provides or configures the first RS/RS resource e.g. NZP-CSI-RS-Resource could also provide or configure the second and third RSs/RS resources e.g. in form/terms of their corresponding RS/resource IDs/indexes.
   In another example, for the fourth association/mapping relation, the higher layer parameter(s)/signaling(s) that provides or configures the second RS/RS resource e.g. NZP-CSI-RS-Resource could also provide or configure the first and third RSs/RS resources e.g. in form/terms of their corresponding RS/resource IDs/indexes.
   In another example, for the fourth association/mapping relation, the higher layer parameter(s)/signaling(s) that provides or configures the third RS/RS resource e.g. NZP-CSI-RS-Resource could also provide or configure the first and second RSs/RS resources e.g. in form/terms of their corresponding RS/resource IDs/indexes.
   In another example, for the fourth association/mapping relation, the UE could be provided or configured or indicated by the network, e.g., via higher layer RRC signaling(s)/parameter(s) and/or MAC CE command(s) and/or dynamic DCI based L1 signaling(s), a look-up table, wherein the first, second and third RS or RS resources—e.g., in terms/form of their RS or RS resource IDs/indexes—could correspond to three neighboring entries, or entries of three neighboring rows, or entries of three neighboring columns in the look-up table.
   In another example, for the fourth association/mapping relation, the first, second and third RSs or RS resources—e.g., in terms/form of their RS/resource IDs/indexes—could be provided or configured in/as a/the same resource set/group; for this design example, the first, second and third RSs or RS resources could be respectively associated to/with a first, a second and a third entity IDs (e.g., provided or configured in higher layer parameter(s)/signaling(s) that provides or configures the resource set/group), wherein the first, second and third entity IDs could be identical or same, or could have a/same value.
   In another example, for the fourth association/mapping relation, the UE could be configured or provided by the network, e.g., via/in/by higher layer RRC signaling(s)/parameter(s) CSI-ReportConfig and/or CSI-ResourceConfig, a first RS or RS resource set provided by csi-RS-FirstResourceSet comprising one or more RSs or RS resources (e.g., in terms/form of their corresponding RS/resource IDs/indexes), a second RS or RS resource set provided by csi-RS-SecondResourceSet comprising one or more RSs or RS resources (e.g., in terms/form of their corresponding RS/resource IDs/indexes), and a third RS or RS resource set provided by csi-RS-ThirdResourceSet comprising one or more RSs or RS resources (e.g., in terms/form of their corresponding RS/resource IDs/indexes). The first, second and third sets of RSs or RS resources could have the same number of RSs or RS resources configured or provided therein, and each RS or RS resource (e.g., in terms/form of its corresponding RS/resource ID/index) in the first (or second or third) set could be associated, mapped or linked to a RS or RS resource (e.g., in terms/form of its corresponding RS/resource ID/index) in the second (or first or third) set and a RS or RS resource (e.g., in terms/form of its corresponding RS/resource ID/index) in the third (or first or second) set; in this case, the UE could determine or identify the association(s), mapping(s) and/or linkage(s) according to or based on one or more of:
      fixed rule(s) in system specification(s) and/or per RRC (re-)configuration: for instance, the k-th entry (hence the corresponding RS/RS resource or RS/RS resource ID/index) of/in the first (or second or third) set could be associated, mapped or linked to the k-th entry (hence the corresponding RS/RS resource or RS/RS resource ID/index) of/in the second (or first or third) set and the k-th entry (hence the corresponding RS/RS resource or RS/RS resource ID/index) of/in the third (or first or second) set, wherein k=1, . . . , K, and K represents the total number of RS(s) or RS resource(s)—e.g., in terms/form the corresponding RS/resource ID(s)/index(es)—configured/provided in the first (or second or third) set. Alternatively, the RS/RS resource with the k-th lowest (or highest) RS/resource ID/index-among all the K≥1 RS(s)/RS resource(s) in the first (or second or third) set wherein k=1, . . . , K-configured/provided in the first (or second or third) set could be associated, mapped or linked to the RS/RS resource with the k-th lowest (or highest) RS/resource ID/index-among all the K≥1 RS(s)/RS resource(s) in the second (or first or third) set wherein k=1, . . . , K-configured/provided in the second (or first or third) set and the RS/RS resource with the k-th lowest (or highest) RS/resource ID/index-among all the K≥1 RS(s)/RS resource(s) in the third (or first or second) set wherein k=1, . . . , K-configured/provided in the third (or first or second) set.
      network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the RS or RS resource in the first (or second or third) set associated/configured with the given RS/RS resource ID/index could be associated, mapped or linked to the RS or RS resource in the second (or first or third) set associated/configured with the (same) given RS/RS resource ID/index and the RS or RS resource in the third (or first or second) set associated/configured with the (same) given RS/RS resource ID/index.
      UE's autonomous determination or selection, which could be further sent or transmitted to the network via various UL channels/signals such as CSI/beam report and/or UE's capability signaling(s)

For this design example, a RS or RS resource (in terms/form of its corresponding or respective RS/resource ID or index)—e.g., corresponding to the aforementioned first RS or RS resource—in the first set and its associated, mapped or linked RS or RS resource (in terms/form of its corresponding or respective RS/resource ID or index)—e.g., corresponding to the aforementioned second RS or RS resource—in the second set could respectively correspond to a sum beam (or a sum beam RS or RS resource) and a difference beam (or a difference beam RS or RS resource) according to or following those specified/defined herein in the present disclosure, or vice versa; alternatively, a RS or RS resource (in terms/form of its corresponding or respective RS/resource ID or index)—e.g., corresponding to the aforementioned first RS or RS resource—in the first set and its associated, mapped or linked RS or RS resource (in terms/form of its corresponding or respective RS/resource ID or index)—e.g., corresponding to the aforementioned third RS or RS resource—in the third set could respectively correspond to a sum beam (or a sum beam RS or RS resource) and a difference beam (or a difference beam RS or RS resource) according to or following those specified/defined herein in the present disclosure, or vice versa; optionally, a RS or RS resource (in terms/form of its corresponding or respective RS/resource ID or index)—e.g., corresponding to the aforementioned second RS or RS resource—in the second set and its associated, mapped or linked RS or RS resource (in terms/form of its corresponding or respective RS/resource ID or index)—e.g., corresponding to the aforementioned third RS or RS resource—in the third set could respectively correspond to a sum beam (or a sum beam RS or RS resource) and a difference beam (or a difference beam RS or RS resource) according to or following those specified/defined herein in the present disclosure, or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned first set, the UE could then determine or identify that the determined or identified RS(s) or RS resource(s) could correspond to a sum (or difference) beam RS(s) or RS resource(s) as specified/defined herein in the present disclosure, and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned second set, the UE could then determine or identify that the determined or identified RS(s) or RS resource(s) could correspond to a difference (or sum) beam RS(s) or RS resource(s) as specified/defined herein in the present disclosure, and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned third set, the UE could then determine or identify that the determined or identified RS(s) or RS resource(s) could correspond to a difference (or sum) beam RS(s) or RS resource(s) as specified/defined herein in the present disclosure.

In this case, when/if the first RS or RS resource is associated with, e.g. indicated in/by, the first TCI state, the UE could identify or determine, based on or according to the fourth association/mapping relation, the second RS or RS resource and/or the third RS or RS resource. In addition, same/similar design considerations as in/to the fourth association/mapping relation as specified/described herein in the present disclosure can be applied/extended to the first, second and third association/mapping relations.

Furthermore, the second (or third) RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.
In another example, the first TCI state (and therefore, the first RS or RS resource) could be associated to a second TCI state and/or a third TCI state, wherein a second (or third) RS or RS resource could be associated with, e.g., indicated in/by, the second (or third) TCI state, and/or the first TCI state could be different/separate from the second TCI state and/or the third TCI state (e.g., in terms/form of their respective TCI state IDs/indexes), and/or the second RS or RS resource could be different or separate from the first RS or RS resource and/or the third RS or RS resource (e.g., in terms/form their respective RS/resource IDs/indexes); for this design example, the UE could determine or identify the association between the first TCI state (and therefore, the first RS or RS resource), the second TCI state (and therefore, the second RS or RS resource) and/or the third TCI state (and therefore, the third RS or RS resource) according to or following one or more of:
   For example, higher layer parameter(s)/signaling(s) e.g. TCI-State that provides or configures the first TCI state could also provide or configure or comprise or include or contain or indicate the second TCI state—e.g., in form/terms of the corresponding TCI state ID/index, and/or the third TCI state—e.g., in form/terms of the corresponding TCI state ID/index; alternatively, higher layer parameter(s)/signaling(s) e.g. TCI-State that provides or configures the second TCI state could also provide or configure or comprise or include or contain or indicate the first TCI state—e.g., in form/terms of the corresponding TCI state ID/index, and/or the third TCI state—e.g., in form/terms of the corresponding TCI state ID/index; optionally, higher layer parameter(s)/signaling(s) e.g. TCI-State that provides or configures the third TCI state could also provide or configure or comprise or include or contain or indicate the first TCI state—e.g., in form/terms of the corresponding TCI state ID/index, and/or the second TCI state—e.g., in form/terms of the corresponding TCI state ID/index; or, higher layer parameter(s)/signaling(s) e.g. TCI-State that provides or configures the first TCI state could also provide or configure or comprise or include or contain or indicate a first entity ID, higher layer parameter(s)/signaling(s) e.g. TCI-State that provides or configures the second TCI state could also provide or configure or comprise or include or contain or indicate a second entity ID, and/or higher layer parameter(s)/signaling(s) e.g. TCI-State that provides or configures the third TCI state could also provide or configure or comprise or include or contain or indicate a third entity ID, wherein the first, second and/or third entity IDs could be identical or same, or could have a/same value.

FIG. 15 illustrates an example of indicating a group of three TCI states for beam tracking 1500 according to embodiments of the present disclosure. The example of indicating a group of three TCI states for beam tracking 1500 as shown in FIG. 15 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, a first association/mapping relation between the first and second TCI states (and therefore, between the first and second RSs/RS resources), a second association/mapping relation between the first and third TCI states (and therefore, between the first and third RSs/RS resources), a third association/mapping relation between the second and third TCI states (and therefore, between the second and third RSs/RS resources), and/or a fourth association/mapping relation between the first, second and third TCI states (and therefore, between the first, second and third RSs/RS resources):
   In one example, for the fourth association/mapping relation, the first, second and third TCI states—e.g., in terms/form of their TCI state IDs/indexes—could be provided or configured in/as a/the same list/set/pool, group and/or pair of TCI states (or TCI state IDs/indexes). In FIG. 15, a conceptual example of a beam group for tracking provided by a higher layer parameter beamGroupForTracking is presented, wherein the beam group for tracking characterizes the aforementioned fourth association/mapping relation.
   In another example, for the fourth association/mapping relation, the first, second and third TCI states—e.g., in terms/form of their TCI state IDs/indexes—could be provided or configured or activated or indicated in/by a/the same higher layer RRC signaling(s)/parameter(s) and/or MAC CE command(s) and/or dynamic DCI based L1 signaling(s).
   In another example, for the fourth association/mapping relation, the higher layer parameter(s)/signaling(s) that provides or configures the first TCI state e.g. TCI-State could also provide or configure a first entity ID, the higher layer parameter(s)/signaling(s) that provides or configures the second TCI state e.g. TCI-State could also provide or configure a second entity ID, and the higher layer parameter(s)/signaling(s) that provides or configures the third TCI state e.g. TCI-State could also provide or configure a third entity ID, wherein the first, second and third entity IDs could be identical or same, or could have a/same value.
   In another example, for the fourth association/mapping relation, the first TCI state e.g. in terms/form of the corresponding TCI state ID/index could be provided or configured in a first list/set/pool/group/pair of TCI state(s) or TCI state ID(s)/index(es) as/corresponding to the k-th entry in/of the first list/set/pool/group/pair, the second TCI state e.g. in terms/form of the corresponding TCI state ID/index could be provided or configured in a second list/set/pool/group/pair of TCI state(s) or TCI state ID(s)/index(es) as/corresponding to the 1-th entry in/of the second list/set/pool/group/pair, and the third TCI state e.g. in terms/form of the corresponding TCI state ID/index could be provided or configured in a third list/set/pool/group/pair of TCI state(s) or TCI state ID(s)/index(es) as/corresponding to the m-th entry in/of the third list/set/pool/group/pair, wherein k=1=m.
   In another example, for the fourth association/mapping relation, the UE could be provided or configured or indicated by the network, e.g., via higher layer RRC signaling(s)/parameter(s) and/or MAC CE command(s) and/or dynamic DCI based L1 signaling(s), a look-up table, wherein the first, second and third TCI states—e.g., in terms/form of their TCI state IDs/indexes—could correspond to three neighboring entries, or entries of three neighboring rows, or entries of three neighboring columns in the look-up table.
   In another example, for the fourth association/mapping relation, the first, second and third TCI states—e.g., in terms/form of their TCI state IDs/indexes—could be provided or configured in/as a/the same list/set/pool of TCI states (or TCI state IDs/indexes); for this design example, the first, second and third TCI states could be respectively associated to/with a first, a second and a third entity IDs (e.g., provided or configured in higher layer parameter(s)/signaling(s) that provides or configures the list/set/pool of TCI states/TCI state IDs/indexes), wherein the first, second and third entity IDs could be identical or same, or could have a/same value.

In this case, when/if the UE has received or indicated or updated by the network the first TCI state (hence the corresponding/associated first RS or RS resource), the UE could identify or determine, based on or according to the fourth association/mapping relation, the second TCI state (hence the corresponding/associated second RS or RS resource), and/or the third TCI state (hence the corresponding/associated third RS or RS resource). In addition, same/similar design considerations as in/to the fourth association/mapping relation as specified/described herein in the present disclosure can be applied/extended to the first, second and third association/mapping relations.

In Particular, the Second (or Third) RS or RS Resource could Correspond to:
Scheme-i: a/the CSI-RS resource/resource configuration—e.g. served as a/the QCL source RS/RS resource—indicated in/by the second (or third) TCI state, wherein the CSI-RS resource/resource configuration could be provided in a CSI resource set configured with ‘repetition’ set to ‘on’, and/or a CSI resource set configured with ‘trs-Info’
Scheme-ii: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the second (or third) TCI state

The UE could determine or identify the second (or third) RS or RS resource following Scheme-i or Scheme-ii based on or according to network's configuration(s)/indication(s)—e.g., Scheme-i or Scheme-ii is enabled for determining or identifying the second RS or RS resource—via higher layer RRC signaling(s)/parameter(s) and/or MAC CE command(s) and/or dynamic DCI based L1 signaling(s) according to or based on a corresponding UE's capability or capability signaling. Alternatively, or optionally, the second (or third) RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.

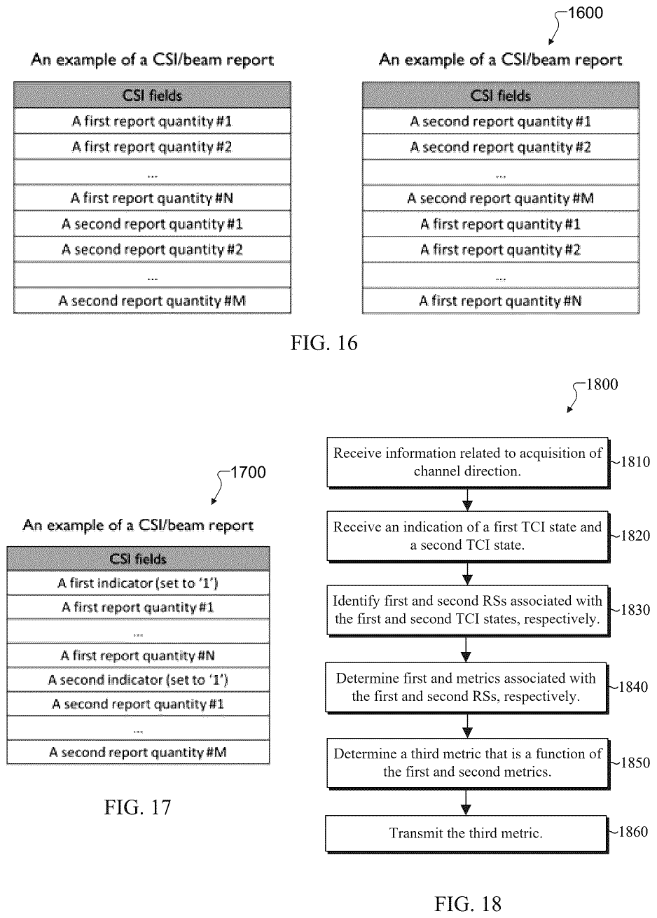

FIG. 16 illustrates an example CSI/beam report 1600 according to embodiments of the present disclosure. The example CSI/beam report 1600 as shown in FIG. 16 is for illustration only and other embodiments can be used without departing from the scope of the present disclosure.

FIG. 17 illustrates another example CSI/beam report 1700 according to embodiments of the present disclosure. The example CSI/beam report 1700 as shown in FIG. 17 is for illustration only and other embodiments can be used without departing from the scope of the present disclosure.

### According to or Following Those Specified Herein in the Present Disclosure,

In one example, the UE could determine or identify the aforementioned first RS or RS resource as a sum beam (or a sum beam RS or RS resource), and the aforementioned second RS or RS resource as a difference beam (or a difference beam RS or RS resource), or vice versa. The UE could then conduct the measurement and/or reporting procedure(s) with respect to or regarding the sum beam (hence the first RS or RS resource) and the difference beam (hence the second RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.
In another example, the UE could determine or identify the aforementioned first RS or RS resource as a sum beam (or a sum beam RS or RS resource), and the aforementioned third RS or RS resource as a difference beam (or a difference beam RS or RS resource), or vice versa. The UE could then conduct the measurement and/or reporting procedure(s) with respect to or regarding the sum beam (hence the first RS or RS resource) and the difference beam (hence the third RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.
In another example, the UE could determine or identify the aforementioned second (or third) RS or RS resource as a sum beam (or a sum beam RS or RS resource), and the aforementioned third (or second) RS or RS resource as a difference beam (or a difference beam RS or RS resource). The UE could then conduct the measurement and/or reporting procedure(s) with respect to or regarding the sum beam (hence the second (or third) RS or RS resource) and the difference beam (hence the third (or second) RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.
In another example, the UE could determine or identify the aforementioned first RS or RS resource as a sum beam (or a sum beam RS or RS resource), and the aforementioned second RS or RS resource as a first difference beam (or a first difference beam RS or RS resource); the UE could then conduct the measurement and/or reporting procedure(s) with respect to or regarding the sum beam (hence the first RS or RS resource) and the first difference beam (hence the second RS or RS resource) according to or following those specified herein in the present disclosure, and obtain corresponding first measurement result(s) that can be reported in a CSI/beam report/reporting instance as first report quantity(s). Furthermore, the UE could determine or identify the aforementioned first RS or RS resource as a/the sum beam (or a/the sum beam RS or RS resource), and the aforementioned third RS or RS resource as a second difference beam (or a second difference beam RS or RS resource); the UE could then conduct the measurement and/or reporting procedure(s) with respect to or regarding the sum beam (hence the first RS or RS resource) and the second difference beam (hence the third RS or RS resource) according to or following those specified herein in the present disclosure, and obtain corresponding second measurement result(s) that can be reported in a CSI/beam report/reporting instance as second report quantity(s).
   For example, the UE could report, in a CSI/beam report or a reporting instance, both the first and second report quantities. The UE could determine or identify order(s) or ordering(s) or position(s) of the first and second report quantities in the CSI/beam report or the reporting instance according to or based on:
      Fixed rule(s) in system specification(s) and/or per RRC (re-)configuration. For instance, the (N≥1) CSI field(s) and the (M≥1) CSI field(s) used in a CSI/beam report or reporting instance to carry or convey the first and second report quantities respectively could be fixed (one conceptual example is presented in FIG. 16), wherein the value(s) of N and/or M could be provided or configured by the network e.g. via higher layer RRC signaling(s)/parameter(s) and/or MAC CE command(s) and/or dynamic DCI based L1 signaling(s) based on or according to a corresponding UE's capability or capability signaling.
      Network's configuration(s) and/or indication(s) e.g. via higher layer RRC signaling(s)/parameter(s) and/or MAC CE command(s) and/or dynamic DCI based L1 signaling(s) based on or according to a corresponding UE's capability or capability signaling. For instance, the UE could be provided or configured by the network a bitmap with each entry/bit position of the bitmap corresponding/associated to a report quantity in the CSI/beam report; when/if an entry/bit position of the bitmap is set to ‘1’ (or ‘0’), the report quantity corresponding/associated to the entry/bit position could correspond to a first report quantity, and when/if an entry/bit position of the bitmap is set to ‘0’ (or ‘1’), the report quantity corresponding/associated to the entry/bit position could correspond to a second report quantity. Alternatively, the UE could be configured or provided by the network, e.g. via higher layer RRC signaling(s)/parameter(s) CSI-ReportConfig, a/the higher layer parameter reportQuantity set to ‘firstAndsecond’, and/or the UE could be enabled or configured by the network, e.g., by setting a/the higher layer parameter reportQuantity in/via/by the higher layer RRC signaling(s)/parameter(s) CSI-ReportConfig to ‘firstAndsecond’, to report in a CSI/beam report or a reporting instance, at least resource indicators (SSBRI(s)/CRI(s)) and/or resource indexes for both the second and third RS or RS resources.
      A UE's autonomous determination, which could be sent or indicated to the network via various UL channels/signals e.g. in part of the CSI/beam report, UE's capability signaling(s) and/or etc. For instance, as illustrated in FIG. 17, the CSI/beam report could comprise, include, contain or indicate a first indicator (e.g., present and/or set to ‘1’) carried or conveyed by a CSI field followed by CSI field(s) that carries or conveys the first report quantity(s), and a second indicator (e.g., present and/or set to ‘1’) carried or conveyed by a CSI field followed by CSI field(s) that carries or conveys the second report quantity(s). Alternatively, the CSI/beam report could comprise, include, contain or indicate a bitmap with each entry/bit position of the bitmap corresponding/associated to a report quantity in the CSI/beam report; when/if an entry/bit position of the bitmap is set to ‘1’ (or ‘0’), the report quantity corresponding/associated to the entry/bit position could correspond to a first report quantity, and when/if an entry/bit position of the bitmap is set to ‘0’ (or ‘1’), the report quantity corresponding/associated to the entry/bit position could correspond to a second report quantity. Optionally, the CSI/beam report could comprise, include, contain or indicate the resource indicator (e.g. SSBRI/CRI) or resource index corresponding to the second RS or RS resource carried or conveyed by a CSI field followed by CSI field(s) that carries or conveys the first report quantity(s), and the resource indicator (e.g., SSBRI/CRI) or resource index corresponding to the third RS or RS resource carried or conveyed by a CSI field followed by CSI field(s) that carries or conveys the second report quantity(s).
   For another example, the UE could report, in a CSI/beam report or a reporting instance, only the first report quantity(s) according to or based on:
      Fixed rule(s) in system specification(s) and/or per RRC (re-)configuration following one or more of: in one example, the beam metric e.g. the measured L1-RSRP for the second RS or RS resource (i.e., the first difference beam) is greater than or equal to that for the third RS or RS resource (i.e., the second difference beam); in another example, the beam metric e.g. the measured L1-RSRP for the second RS or RS resource (i.e., the first difference beam) is greater than that for the third RS or RS resource (i.e., the second difference beam) by a first threshold; in another example, the beam metric e.g. the measured L1-RSRP for the second RS or RS resource (i.e., the first difference beam) is greater than or equal to a second threshold, and/or the beam metric e.g. the measured L1-RSRP for the third RS or RS resource (i.e., the second difference beam) is less than or equal to a third threshold; in another example, the beam metric e.g. the measured L1-RSRP for the first RS or RS resource (i.e., the sum beam) is less (or greater) than or equal to a fourth threshold, and the beam metric e.g. the measured L1-RSRP for the second RS or RS resource (i.e., the first difference beam) is greater than or equal to a fifth threshold; in another example, the beam metric e.g. the measured L1-RSRP for the first RS or RS resource (i.e., the sum beam) is less (or greater) than or equal to the fourth threshold, and the beam metric e.g. the measured L1-RSRP for the third RS or RS resource (i.e., the second difference beam) is less than or equal to a sixth threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is less than or equal to a sixth threshold; in another example, the difference between the beam metric e.g. the measured L1-RSRP for the first RS or RS resource (i.e., the sum beam) and the beam metric e.g. the measured L1-RSRP for the third RS or RS resource (i.e., the second difference beam) is greater than or equal to a seven threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is less than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam); in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is less than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam) by an eighth threshold. The UE could determine or identify the first, second, third, fourth, fifth, sixth, seventh and/or eighth threshold(s) according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
      Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling. For instance, the UE could be provided or configured by the network, e.g., via higher layer RRC signaling(s)/parameter(s), a higher layer parameter reportQuantityType; when/if the higher layer parameter reportQuantityType is set to ‘first’, the UE could report, in a CSI/beam report or a reporting instance, only the first report quantity(s). Alternatively, the UE could be configured or provided by the network, e.g. via higher layer RRC signaling(s)/parameter(s) CSI-ReportConfig, a/the higher layer parameter reportQuantity set to ‘firstOnly’, and/or the UE could be enabled or configured by the network, e.g., by setting a/the higher layer parameter reportQuantity in/via/by the higher layer RRC signaling(s)/parameter(s) CSI-ReportConfig to ‘firstOnly’, to report in a CSI/beam report or a reporting instance, at least the resource indicator (SSBRI/CRI) and/or resource index for the second RS or RS resources.
      UE's autonomous determination, which could be sent or indicated to the network via various UL channels/signals e.g. in part of the CSI/beam report, UE's capability signaling(s) and/or etc. For instance, the CSI/beam report could comprise, include, contain or indicate a one-bit report quantity type indicator; in this case, when/if the report quantity type indicator is set to ‘1’ (or ‘0’), all the report quantity(s) in the CSI/beam report could correspond to the first report quantity(s). Optionally, the CSI/beam report could comprise, include, contain or indicate only the resource indicator (e.g. SSBRI/CRI) or resource index corresponding to the second RS or RS resource; in this case, all the report quantity(s) in the CSI/beam report could correspond to the first report quantity(s).
   For another example, the UE could report, in a CSI/beam report or a reporting instance, only the second report quantity(s) according to or based on:
      Fixed rule(s) in system specification(s) and/or per RRC (re-)configuration following one or more of: in one example, the beam metric e.g. the measured L1-RSRP for the second RS or RS resource (i.e., the first difference beam) is less than or equal to that for the third RS or RS resource (i.e., the second difference beam); in another example, the beam metric e.g. the measured L1-RSRP for the second RS or RS resource (i.e., the first difference beam) is less than that for the third RS or RS resource (i.e., the second difference beam) by a first threshold; in another example, the beam metric e.g. the measured L1-RSRP for the second RS or RS resource (i.e., the first difference beam) is less than or equal to a second threshold, and/or the beam metric e.g. the measured L1-RSRP for the third RS or RS resource (i.e., the second difference beam) is greater than or equal to a third threshold; in another example, the beam metric e.g. the measured L1-RSRP for the first RS or RS resource (i.e., the sum beam) is less (or greater) than or equal to a fourth threshold, and the beam metric e.g. the measured L1-RSRP for the second RS or RS resource (i.e., the first difference beam) is less than or equal to a fifth threshold; in another example, the beam metric e.g. the measured L1-RSRP for the first RS or RS resource (i.e., the sum beam) is less (or greater) than or equal to the fourth threshold, and the beam metric e.g. the measured L1-RSRP for the third RS or RS resource (i.e., the second difference beam) is greater than or equal to a sixth threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is greater than or equal to a sixth threshold; in another example, the difference between the beam metric e.g. the measured L1-RSRP for the first RS or RS resource (i.e., the sum beam) and the beam metric e.g. the measured L1-RSRP for the third RS or RS resource (i.e., the second difference beam) is less than or equal to a seven threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is greater than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam); in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is greater than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam) by an eighth threshold. The UE could determine or identify the first, second, third, fourth, fifth, sixth, seventh and/or eighth threshold(s) according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
      Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling. For instance, the UE could be provided or configured by the network, e.g., via higher layer RRC signaling(s)/parameter(s), a higher layer parameter reportQuantityType; when/if the higher layer parameter reportQuantityType is set to ‘second’, the UE could report, in a CSI/beam report or a reporting instance, only the second report quantity(s). Alternatively, the UE could be configured or provided by the network, e.g. via higher layer RRC signaling(s)/parameter(s) CSI-ReportConfig, a/the higher layer parameter reportQuantity set to ‘secondOnly’, and/or the UE could be enabled or configured by the network, e.g., by setting a/the higher layer parameter reportQuantity in/via/by the higher layer RRC signaling(s)/parameter(s) CSI-ReportConfig to ‘secondOnly’, to report in a CSI/beam report or a reporting instance, at least the resource indicator (SSBRI/CRI) and/or resource index for the third RS or RS resources.
      UE's autonomous determination, which could be sent or indicated to the network via various UL channels/signals e.g. in part of the CSI/beam report, UE's capability signaling(s) and/or etc. For instance, the CSI/beam report could comprise, include, contain or indicate a one-bit report quantity type indicator; in this case, when/if the report quantity type indicator is set to ‘0’ (or ‘1’), all the report quantity(s) in the CSI/beam report could correspond to the second report quantity(s). Optionally, the CSI/beam report could comprise, include, contain or indicate only the resource indicator (e.g. SSBRI/CRI) or resource index corresponding to the third RS or RS resource; in this case, all the report quantity(s) in the CSI/beam report could correspond to the second report quantity(s).

According to or following those specified or defined herein in the present disclosure, the UE could be provided or configured by the network, e.g., via higher layer RRC signaling(s)/parameter(s), a higher layer parameter reportQuantityType; in this case, when/if the higher layer parameter reportQuantityType is set to ‘first’, the UE could report, in a CSI/beam report or a reporting instance, only the first report quantity(s), when/if the higher layer parameter reportQuantityType is set to ‘second’, the UE could report, in a CSI/beam report or a reporting instance, only the second report quantity(s), and when/if the higher layer parameter reportQuantityType is set to ‘both’, the UE could report, in a CSI/beam report or a reporting instance, both the first and the second report quantities; furthermore, when/if the higher layer parameter reportQuantityType is absent or is not configured/present/provided in the corresponding higher layer RRC signaling(s)/parameter(s), the UE could report, in a CSI/beam report or a reporting instance,
only the first report quantity(s), or
only the second report quantity(s), or
both the first and second report quantities.

Optionally, the CSI/beam report could comprise, include, contain or indicate a report quantity type indicator; in this case, when/if the report quantity type indicator is set to ‘0’ (or ‘1’) or ‘00’ (or ‘01’ or ‘10’ or ‘11’), all the report quantity(s) in the CSI/beam report could correspond to the first report quantity(s), when/if the report quantity type indicator is set to ‘1’ (or ‘0’) or ‘01’ (or ‘00’ or ‘10’ or ‘11’), all the report quantity(s) in the CSI/beam report could correspond to the second report quantity(s), and when/if the report quantity type indicator is set to ‘10’ (or ‘00’ or ‘01’ or ‘11’ or ‘0’ or ‘1’), the report quantity(s) in the CSI/beam report could correspond to both the first and second report quantities; furthermore, when/if the report quantity type indicator is absent or is not indicated/present/provided in the corresponding CSI/beam report, the report quantity(s) in the CSI/beam report could correspond to,
only the first report quantity(s), or
only the second report quantity(s), or
both the first and second report quantities.

The UE may expect to receive from the network a corresponding response—e.g., a TCI state switching/update for beam tracking based on the reported measurement result(s) e.g. the first and/or second report quantity(s)—according to or following those specified herein in the present disclosure.
In another example, the UE could determine or identify the aforementioned first RS or RS resource as a sum beam (or a sum beam RS or RS resource), and the aforementioned second RS or RS resource as a first difference beam (or a first difference beam RS or RS resource); the UE could then conduct the measurement and/or reporting procedure(s) with respect to or regarding the sum beam (hence the first RS or RS resource) and the first difference beam (hence the second RS or RS resource) according to or following those specified herein in the present disclosure, and obtain corresponding first measurement result(s) that can be reported in a CSI/beam report/reporting instance as first report quantity(s). Furthermore, the UE could determine or identify the aforementioned first RS or RS resource as a/the sum beam (or a/the sum beam RS or RS resource), and the aforementioned third RS or RS resource as a second difference beam (or a second difference beam RS or RS resource); the UE could then conduct the measurement and/or reporting procedure(s) with respect to or regarding the sum beam (hence the first RS or RS resource) and the second difference beam (hence the third RS or RS resource) according to or following those specified herein in the present disclosure, and obtain corresponding second measurement result(s) that can be reported in a CSI/beam report/reporting instance as second report quantity(s). In addition, the UE could determine or identify the aforementioned second RS or RS resource as a sum (or difference) beam (or a sum (or difference) beam RS or RS resource), and the aforementioned third RS or RS resource as a difference (or sum) beam (or a difference (sum) beam RS or RS resource); the UE could then conduct the measurement and/or reporting procedure(s) with respect to or regarding the sum beam (hence the second (or third) RS or RS resource) and the difference beam (hence the third (or second) RS or RS resource) according to or following those specified herein in the present disclosure, and obtain corresponding third measurement result(s) that can be reported in a CSI/beam report/reporting instance as third report quantity(s). For this design example, the UE could determine or identify to report, in a CSI/beam report or a reporting instance, the first report quantity(s), the second report quantity(s) and/or the third report quantity(s) according to or based on those specified or described herein in the present disclosure—e.g., those specified or described for reporting the first and/or second report quantity(s) in the above design examples. When/if the UE report, in a CSI/beam report or a reporting instance, (i) both the first and second report quantities, (ii) both the first and third report quantities, (iii) both the second and third report quantities, or (iv) the first, second and third report quantities, the UE could determine or identify order(s) or ordering(s) or position(s) of the first, second and/or third report quantities in the CSI/beam report or the reporting instance according to or based on those specified or defined herein in the present disclosure—e.g., those specified or described for reporting the first and second report quantities in a CSI/beam report or a reporting instance. The UE may expect to receive from the network a corresponding response—e.g., a TCI state switching/update for beam tracking based on the reported measurement result(s) e.g. the first, second and/or third report quantity(s)—according to or following those specified herein in the present disclosure.

After a UE has sent or transmitted to the network, in a/the CSI/beam report or a/the reporting instance, the first, second and/or third report quantity(s) according to or following those specified herein in the present disclosure, the UE could expect to receive form the network a corresponding response e.g. (i) X symbol(s)/slot(s)/etc. after a last symbol/slot/etc. of transmission of the CSI/beam report, and/or (ii) within Y symbol(s)/slot(s)/etc. after a last symbol/slot/etc. of transmission of the CSI/beam report, wherein the UE could determine or identify value(s) of X and/or Y according to or based on: (i) fixed value(s) in system specification(s) and/or per RRC (re-) configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s). Furthermore, the network's response could be in form of one or more of:
A one-bit ACK/NACK indicator
A TCI state update indicated e.g. via a codepoint of a (unified) TCI state(s) activation/deactivation MAC CE and/or a TCI codepoint of a/the TCI field in a beam indication DCI (e.g., DCI format(s) 1_1/1_2 with or without DL assignment)

When/if the network's response is indicated via a DCI, the network's response could be provided to the UE via a new/dedicated DCI field, or by repurposing one or more codepoints of one or more existing DCI fields in the corresponding DCI format(s).

The design examples specified or described herein in the present disclosure for the first and second RSs or RS resources could be extended or applied to case(s) when/if more than two RSs or RS resources are used as sum and difference beams for beam tracking. Furthermore, the design examples specified or described herein in the present disclosure for the first, second and third RSs or RS resources could be extended or applied to case(s) when/if more than three RSs or RS resources are used as sum and difference beams for beam tracking. A UE could conduct measurement(s) and reporting(s) for beam tracking via the sum and difference beams following those specified or defined or described herein in the present disclosure when/if the UE is provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, that the sum/difference beam(s) based beam tracking is enabled; for instance, when/if the UE is configured or provided by the network, e.g., via higher layer RRC signaling(s)/parameter(s), a higher layer parameter sumdiffBeamsForTracking and/or set to ‘enabled’, the UE could conduct measurement(s) and reporting(s) for beam tracking via the sum and difference beams following those specified or defined or described herein in the present disclosure; optionally, or alternatively, when/if the UE is configured or provided by the network, e.g., in/via/by higher layer RRC signaling(s)/parameter(s) e.g. in CSI-ReportConfig, the higher layer parameter reportQuantity set to ‘sumdiffBeamforTracking’, the UE could conduct measurement(s) and reporting(s) for beam tracking via the sum and difference beams following those specified or defined or described herein in the present disclosure. Throughout the present disclosure, the higher layer parameter/signaling CSI-ReportConfig is equivalent to the higher layer parameter/signaling CSI-ResourceConfig, and they can be used in an exchangeable manner.

FIG. 18 illustrates an example method 1800 performed by a UE in a wireless communication system according to embodiments of the present disclosure. The method 1800 of FIG. 18 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1800 is for illustration only and other embodiments can be used without departing from the scope of the present disclosure.

The method 1800 begins with the UE receiving information related to acquisition of channel direction (1810). In various embodiments, the information includes a report quantity related to acquisition of channel direction, includes a set of one or more candidate TCI states, and is signaled via a RRC signaling. The UE then receives an indication of a first TCI state and a second TCI state (1820). In some examples, the indication of the first and second TCI states is from the set of one or more candidate TCI states and is signaled via a DCI. The UE then identifies first and second RSs associated with the first and second TCI states, respectively (1830). In various embodiments, the first and second RSs are SS/PBCH blocks quasi-co-located with reference signals in the first and second TCI states, respectively, or reference signals in the first and second TCI states, respectively.

The UE then determines first and metrics associated with the first and second RSs, respectively (1840). For example, the determination in 1840 may be made based on the information received in 1810. The UE then determines a third metric that is a function of the first and second metrics (1850). For example, the determination in 1850 may be made based on the information received in 1810. In various embodiments, the first and second metrics are L1-RSRPs denoted by L1-RSRP_1 and L1-RSRP_2, respectively, and the third metric is (L1-RSRP_1-L1-RSRP_2)/(L1-RSRP_1+L1-RSRP_2). In various embodiments, the first and second metrics are receive signal samples denoted by sig_1 and sig_2, respectively, and the third metric is an imaginary part of sig_1 divided by a real part of sig_2. The UE then transmits the third metric (1860). In various embodiments, the third metric is selected from an entry in a set of candidate values and transmitted in a channel state information CSI report.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive information related to acquisition of channel direction; and
receive an indication of a first transmission configuration indication (TCI) state and a second TCI state; and
a processor operably coupled with the transceiver, the processor configured to:
identify a first reference signal (RS) and a second RS associated with the first and second TCI states, respectively;
determine, based on the information, a first metric and a second metric associated with the first and second RSs, respectively; and
determine a third metric based on the information, wherein the third metric is a function of the first and second metrics,
wherein the transceiver is further configured to transmit the third metric.

2. The UE of claim 1, wherein the information:
includes a report quantity related to acquisition of channel direction,
includes a set of one or more candidate TCI states, and
is signaled via a radio resource control (RRC) signaling.

3. The UE of claim 2, wherein:
the indication of the first and second TCI states is from the set of one or more candidate TCI states, and
the indication is signaled via a downlink control information (DCI).

4. The UE of claim 1, wherein the first and second RSs are:
synchronization signal/physical broadcast channel (SS/PBCH) blocks quasi-co-located with reference signals in the first and second TCI states, respectively, or
reference signals in the first and second TCI states, respectively.

5. The UE of claim 1, wherein:
the first and second metrics are layer-1 reference signal receive powers (L1-RSRPs) denoted by L1-RSRP_1 and L1-RSRP_2, respectively, and
the third metric is (L1-RSRP_1−L1-RSRP_2)/(L1−RSRP_1+L1−RSRP_2).

6. The UE of claim 1, wherein:
the first and second metrics are receive signal samples denoted by sig_1 and sig_2, respectively, and
the third metric is an imaginary part of sig_1 divided by a real part of sig_2.

7. The UE of claim 1, wherein the third metric is:
selected from an entry in a set of candidate values, and
transmitted in a channel state information (CSI) report.

8. A base station, comprising:
a processor, and
a transceiver operably coupled with the processor, the transceiver configured to:
transmit information related to acquisition of channel direction;
transmit an indication of a first transmission configuration indication (TCI) state and a second TCI state, wherein a first reference signal (RS) and a second RS are associated with the first and second TCI states, respectively; and
receive a third metric that is a function of first and second metrics, wherein the first metric and the second metric are associated with the first and second RSs, respectively.

9. The base station of claim 8, wherein the information:
includes a report quantity related to acquisition of channel direction,
includes a set of one or more candidate TCI states, and
is signaled via a radio resource control (RRC) signaling.

10. The base station of claim 9, wherein:
the indication of the first and second TCI states is from the set of one or more candidate TCI states, and
the indication is signaled via a downlink control information (DCI).

11. The base station of claim 8, wherein the first and second RSs are:
synchronization signal/physical broadcast channel (SS/PBCH) blocks quasi-co-located with reference signals in the first and second TCI states, respectively, or
reference signals in the first and second TCI states, respectively.

12. The base station of claim 8, wherein:
the first and second metrics are layer-1 reference signal receive powers (L1-RSRPs) denoted by L1-RSRP_1 and L1-RSRP_2, respectively, and
the third metric is (L1-RSRP_1-L1-RSRP_2)/(L1-RSRP_1+L1-RSRP_2).

13. The base station of claim 8, wherein:
the first and second metrics are receive signal samples denoted by sig_1 and sig_2, respectively, and
the third metric is an imaginary part of sig_1 divided by a real part of sig_2.

14. The base station of claim 8, wherein the third metric is:
based on an entry in a set of candidate values, and
received in a channel state information (CSI) report.

15. A method performed by a user equipment (UE), the method comprising:
receiving information related to acquisition of channel direction;
receiving an indication of a first transmission configuration indication (TCI) state and a second TCI state;
identifying a first reference signal (RS) and a second RS associated with the first and second TCI states, respectively;
determining, based on the information, a first metric and a second metric associated with the first and second RSs, respectively;
determining a third metric based on the information, wherein the third metric is a function of the first and second metrics; and
transmitting the third metric.

16. The method of claim 15, wherein the information:
includes a report quantity related to acquisition of channel direction,
includes a set of one or more candidate TCI states, and
is signaled via a radio resource control (RRC) signaling.

17. The method of claim 16, wherein:
the indication of the first and second TCI states is from the set of one or more candidate TCI states, and
the indication is signaled via a downlink control information (DCI).

18. The method of claim 15, wherein the first and second RSs are:
synchronization signal/physical broadcast channel (SS/PBCH) blocks quasi-co-located with reference signals in the first and second TCI states, respectively, or
reference signals in the first and second TCI states, respectively.

19. The method of claim 15, wherein:
the first and second metrics are layer-1 reference signal receive powers (L1-RSRPs) denoted by L1-RSRP_1 and L1-RSRP_2, respectively, and
the third metric is (L1-RSRP_1-L1-RSRP_2)/(L1-RSRP_1+L1-RSRP_2).

20. The method of claim 15, wherein:
the first and second metrics are receive signal samples denoted by sig_1 and sig_2, respectively, and
the third metric is an imaginary part of sig_1 divided by a real part of sig_2.
